(19) United States
(12) Patent Application Publication
(10) Pub. No.: US 2023/0298025 A1
(43) Pub. Date: Sep. 21, 2023

(54) VALUE TRANSFER APPARATUS, VALUE TRANSFER SYSTEM, VALUE TRANSFER METHOD, AND NON-TRANSITORY COMPUTER-READABLE MEDIUM

(71) Applicant: NEC Corporation, Minato-ku, Tokyo (JP)

(72) Inventors: Risa TAGAWA, Tokyo (JP); Noriyuki HIRAMOTO, Tokyo (JP)

(73) Assignee: NEC Corporation, Minato-ku, Tokyo (JP)

(21) Appl. No.: 18/016,560

(22) PCT Filed: Jul. 17, 2020
(86) PCT No.: PCT/JP2020/027971

§ 371 Date: Jan. 17, 2023

(51) Int. Cl. G06Q 20/40; G06V 40/16

(52) U.S. Cl. CPC G06Q 20/40145; G06V 40/172

(57) ABSTRACT

A value transfer apparatus (10) includes: an acquisition unit (11) configured to acquire a captured image including a plurality of users; an authentication control unit (12) configured to control biometric authentication of biometric information of each of the plurality of users extracted from the captured image; an output unit (13) configured to output a list of two or more users the biometric authentication of whom is successful to an external terminal; an acceptance unit (14) configured to accept, from the external terminal, selection of a transfer source user and a transfer destination user of electronic value information from the list and input of a transferred portion of the value information; and a transfer control unit (15) configured to perform transfer control of the transferred portion from the transfer source user to the transfer destination user.

### TECHNICAL FIELD

The present invention relates to a value transfer apparatus, a value transfer system, a value transfer method, and a non-transitory computer-readable medium and particularly relates to a value transfer apparatus, a value transfer system, a value transfer method, and a non-transitory computer-readable medium for transferring value information being electronic data indicating an economical value.

### BACKGROUND ART

It is common to award points to a user according to the size of a commercial transaction and returning a service based on accumulated points to the user. It is also considered to use a biometric authentication technology such as face authentication for acquisition of points.

Patent Literature 1 discloses a technology related to a system for specifying a casino customer by using biometric authentication data. The system specifies a user biometric authentication of whom is successful and tracks the specified user. Further, Patent Literature 2 discloses a technology related to electronic equipment supporting a point system. The electronic equipment is used for transferring points acquired in the point system to another person.

### CITATION LIST

### Patent Literature

Patent Literature 1: Japanese Unexamined Patent Application Publication No. 2020-047260
Patent Literature 2: Japanese Unexamined Patent Application Publication No. 2002-015200

### SUMMARY OF INVENTION

### Technical Problem

There is room for utilization of a biometric authentication technology for promoting use of electronic value information such as points.

The present disclosure has been made in order to solve such a problem, and an object of the present disclosure is to provide a value transfer apparatus, a value transfer system, a value transfer method, and a non-transitory computer-readable medium for promoting use of value information by simplifying transfer of value information by using biometric authentication.

### Solution to Problem

A value transfer apparatus according to a first aspect of the present disclosure includes:
an acquisition means for acquiring a captured image including a plurality of users;
an authentication control means for controlling biometric authentication of biometric information of each of the plurality of users extracted from the captured image;
an output means for outputting a list of two or more users the biometric authentication of whom is successful to an external terminal;
an acceptance means for accepting, from the external terminal, selection of a transfer source user and a transfer destination user of electronic value information from the list and input of a transferred portion of the value information; and
a transfer control means for performing transfer control of the transferred portion from the transfer source user to the transfer destination user.

A value transfer system according to a second aspect of the present disclosure includes:
a face authentication terminal configured to capture a captured image including a plurality of users; and
a value transfer apparatus,
wherein the value transfer apparatus includes:
   an acquisition means for acquiring the captured image from the face authentication terminal;
   an authentication control means for controlling biometric authentication of biometric information of each of the plurality of users extracted from the captured image;
   an output means for outputting a list of two or more users the biometric authentication of whom is successful to the face authentication terminal;
   an acceptance means for accepting, from the face authentication terminal, selection of a transfer source user and a transfer destination user of electronic value information from the list and input of a transferred portion of the value information; and
   a transfer control means for performing transfer control of the transferred portion from the transfer source user to the transfer destination user.

A value transfer method according to a third aspect of the present disclosure includes, by a computer:
acquiring a captured image including a plurality of users;
controlling biometric authentication of biometric information of each of the plurality of users extracted from the captured image;
outputting a list of two or more users the biometric authentication of whom is successful to an external terminal;
accepting, from the external terminal, selection of a transfer source user and a transfer destination user of electronic value information from the list and input of a transferred portion of the value information; and
performing transfer control of the transferred portion from the transfer source user to the transfer destination user.

A non-transitory computer-readable medium storing a value transfer program according to a fourth aspect of the present disclosure causes a computer to execute:
acquisition processing of acquiring a captured image including a plurality of users;
authentication control processing of controlling biometric authentication of biometric information of each of the plurality of users extracted from the captured image;
output processing of outputting a list of two or more users the biometric authentication of whom is successful to an external terminal;
acceptance processing of accepting, from the external terminal, selection of a transfer source user and a transfer destination user of electronic value information from the list and input of a transferred portion of the value information; and
transfer control processing of performing transfer control of the transferred portion from the transfer source user to the transfer destination user.

### Advantageous Effects of Invention

The present disclosure can provide a value transfer apparatus, a value transfer system, a value transfer method, and a non-transitory computer-readable medium for promoting use of value information by simplifying transfer of value information by using biometric authentication.

### BRIEF DESCRIPTION OF DRAWINGS

FIG. 1 is a block diagram illustrating a configuration of a value transfer apparatus according to a first example embodiment;

FIG. 2 is a flowchart illustrating a flow of a value transfer method according to the first example embodiment;

FIG. 3 is a block diagram illustrating an entire configuration of a value transfer system according to a second example embodiment;

FIG. 4 is a block diagram illustrating a configuration of an authentication apparatus according to the second example embodiment;

FIG. 5 is a flowchart illustrating a flow of face information registration processing according to the second example embodiment;

FIG. 6 is a flowchart illustrating a flow of face authentication processing by the authentication apparatus according to the second example embodiment;

FIG. 7 is a block diagram illustrating a configuration of a face authentication terminal according to the second example embodiment;

FIG. 8 is a block diagram illustrating a configuration of a value transfer apparatus according to the second example embodiment;

FIG. 9 is a sequence diagram illustrating a flow of value transfer processing according to the second example embodiment;

FIG. 10 is a diagram illustrating an example of a user list display screen according to the second example embodiment;

FIG. 11 is a diagram illustrating a selection example of a transfer source user according to the second example embodiment;

FIG. 12 is a diagram illustrating a selection example of a transfer destination user and a transferred points input example, according to the second example embodiment;

FIG. 13 is a diagram illustrating an example of a transfer result display screen according to the second example embodiment;

FIG. 14 is a diagram illustrating another selection example of a transfer source and a transfer destination, according to the second example embodiment;

FIG. 15 is a block diagram illustrating an entire configuration of a value transfer system according to a third example embodiment;

FIG. 16 is a block diagram illustrating a configuration of a value transfer apparatus according to the third example embodiment;

FIG. 17 is a sequence diagram illustrating a flow of value transfer processing according to the third example embodiment;

FIG. 18 is a flowchart illustrating a flow of transfer processing according to the third example embodiment;

FIG. 19 is a diagram illustrating an example of a user list display screen according to the third example embodiment;

FIG. 20 is a diagram illustrating a selection example of a transfer source user and an input example of a transferred quantity, according to the third example embodiment;

FIG. 21 is a diagram illustrating a selection example of a transfer destination user and an input example of a received quantity, according to the third example embodiment;

FIG. 22 is a diagram illustrating an example of a transfer result display screen according to the third example embodiment;

FIG. 23 is a block diagram illustrating an entire configuration of a value transfer system according to a fourth example embodiment;

FIG. 24 is a block diagram illustrating a configuration of a value transfer apparatus according to the fourth example embodiment;

FIG. 25 is a sequence diagram illustrating a flow of value transfer processing according to the fourth example embodiment;

FIG. 26 is a sequence diagram illustrating a flow of value transfer processing according to a fifth example embodiment;

FIG. 27 is a diagram illustrating a selection example of a transfer destination user and an input example of a user ID, according to the fifth example embodiment; and

FIG. 28 is a block diagram illustrating a configuration of a value transfer apparatus according to a sixth example embodiment.

### EXAMPLE EMBODIMENT

Example embodiments of the present disclosure will be described in detail below with reference to drawings. In each drawing, identical or corresponding components are given an identical sign, and duplicated description thereof is omitted as appropriate for clarification of description.

### First Example Embodiment

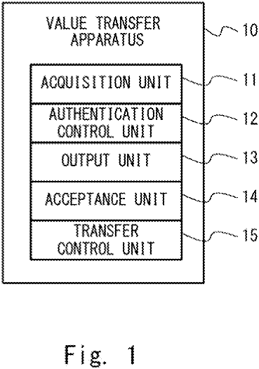

FIG. 1 is a block diagram illustrating a configuration of a value transfer apparatus 10 according to a first example embodiment. The value transfer apparatus 10 is an information processing apparatus for transferring value information being electronic data indicating an economical value from one or more users to one or more other users. The value transfer apparatus 10 is connected to a network (unillustrated). The network may be wired or wireless. Further, an external terminal (unillustrated) is connected to the network. The external terminal captures an image of any user, transmits the captured image to the value transfer apparatus 10 through the network, and displays information received from the value transfer apparatus 10 on a screen. Further, the external terminal transmits a transferred portion of value information input by a user to the value transfer apparatus 10 through the network.

The value transfer apparatus 10 includes an acquisition unit 11, an authentication control unit 12, an output unit 13, an acceptance unit 14, and a transfer control unit 15. The acquisition unit 11 acquires a captured image including a plurality of users. The authentication control unit 12 controls biometric authentication of biometric information of each of the plurality of users extracted from the captured image. Examples of the biometric information include face feature information, iris information, and fingerprint information. When biometric information of a plurality of persons is previously saved in the value transfer apparatus 10, the authentication control unit 12 performs authentication processing. Alternatively, when face feature information of a plurality of persons is previously saved in an authentication apparatus external to the value transfer apparatus 10, the authentication control unit 12 causes the authentication apparatus to perform authentication and acquires the authentication result.

The output unit 13 outputs a list of two or more users biometric authentication of whom is successful to the external terminal. The acceptance unit 14 accepts, from the external terminal, selection of a transfer source user and a transfer destination user of electronic value information from the list and input of a transferred portion of the value information. The transfer control unit 15 performs transfer control of the transferred portion from the transfer source user to the transfer destination user.

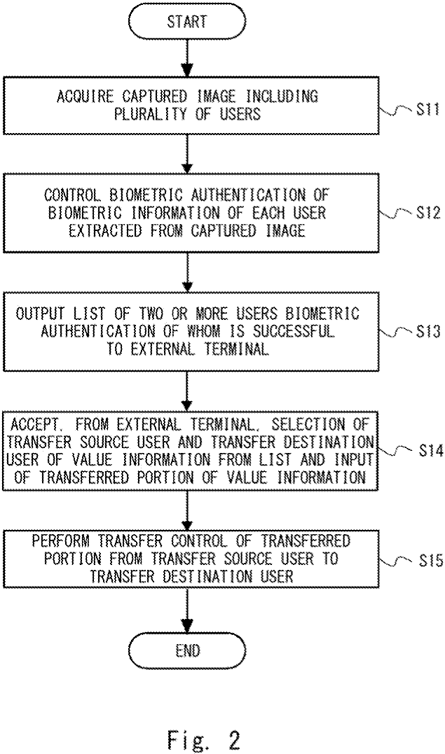

FIG. 2 is a flowchart illustrating a flow of a value transfer method according to the first example embodiment. First, the acquisition unit 11 acquires a captured image including a plurality of users (S11). Next, the authentication control unit 12 controls biometric authentication of biometric information of each user extracted from the captured image (S12). Then, the output unit 13 outputs a list of two or more users biometric authentication of whom is successful to the external terminal (S13). Next, the acceptance unit 14 accepts, from the external terminal, selection of a transfer source user and a transfer destination user of electronic value information from the list and input of a transferred portion of the value information (S14). Subsequently, the transfer control unit 15 performs transfer control of the transferred portion from the transfer source user to the transfer destination user (S15).

Thus, by simplifying transfer of value information by using biometric authentication, the present example embodiment can support circulation of value information and promote use of value information.

The value transfer apparatus 10 includes a processor, a memory, and a storage device as unillustrated components. Further, the storage device stores a computer program in which processing in an image providing method according to the present example embodiment is implemented. Then, the processor causes the computer program to be read into the memory from the storage device and executes the computer program. Thus, the processor provides functions of the acquisition unit 11, the authentication control unit 12, the output unit 13, the acceptance unit 14, and the transfer control unit 15.

Alternatively, each of the acquisition unit 11, the authentication control unit 12, the output unit 13, the acceptance unit 14, and the transfer control unit 15 may be provided by dedicated hardware. Further, part or the whole of each component in each device may be provided by general-purpose or dedicated circuitry, a processor, or the like, or a combination thereof. The above may be configured with a single chip or a plurality of chips connected through a bus. Part or the whole of each component in each device may be provided by a combination of the aforementioned circuitry or the like and a program. Further, examples of a processor that may be used include a central processing unit (CPU), a graphics processing unit (GPU), and a field-programmable gate array (FPGA).

Further, when part or the whole of each component in the value transfer apparatus 10 is provided by a plurality of information processing apparatuses, a plurality of pieces of circuitry, or the like, the plurality of information processing apparatus, the plurality of pieces of circuitry, or the like may be placed in a concentrated manner or be placed in a distributed manner. For example, the information processing apparatuses, the pieces of circuitry, or the like may be provided in a topology of being connected to each other through a communication network, such as a client-server system or a cloud computing system. Further, the functions of the value transfer apparatus 10 may be provided in a software as a service (SaaS) style.

### Second Example Embodiment

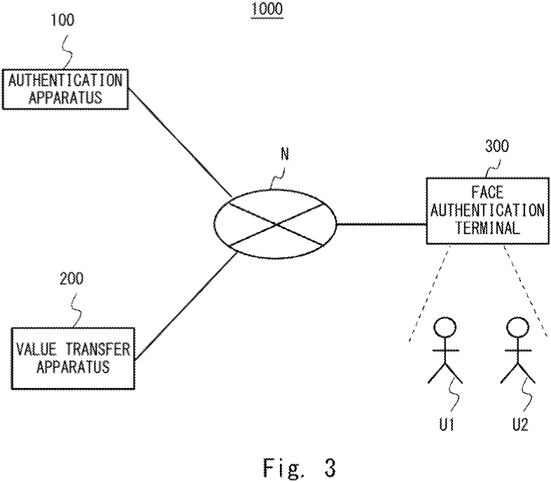

A second example embodiment is a specific example of the aforementioned first example embodiment. FIG. 3 is a block diagram illustrating an entire configuration of a value transfer system 1000 according to the second example embodiment. The value transfer system 1000 is an information system for performing face authentication of a user included in a captured image, accepting selection of a transfer source and a transfer destination of points from a list of users face authentication of whom is successful and input of a transferred portion, and performing transfer control of points being the transferred portion from the transfer source to the transfer destination. While it is assumed in the following description that biometric authentication is face authentication and biometric information is face feature information, another technology using a captured image is applicable to the biometric authentication and the biometric information. For example, data (a feature value) calculated from a physical feature unique to an individual, such as a fingerprint, a voiceprint, a vein, a retina, or a pattern of an iris of an eye, may be used as the biometric information.

The value transfer system 1000 includes an authentication apparatus 100, a value transfer apparatus 200, and a face authentication terminal 300. The authentication apparatus 100, the value transfer apparatus 200, and the face authentication terminal 300 are connected to each other through a network N. The network N includes wired or wireless communication lines.

The authentication apparatus 100 is an information processing apparatus for storing face feature information of a plurality of users. Further, in response to an externally received face authentication request, the authentication apparatus 100 checks a facial image or face feature information included in the request against face feature information of each user and returns the checking result (authentication result) to the requester.

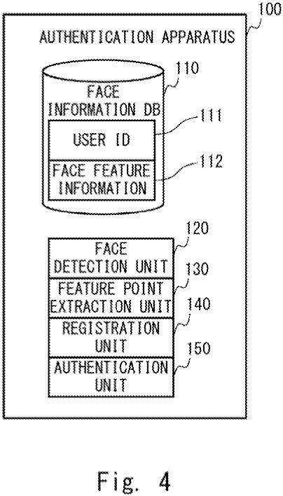

FIG. 4 is a block diagram illustrating a configuration of the authentication apparatus 100 according to the second example embodiment. The authentication apparatus 100 includes a face information database (DB) 110, a face detection unit 120, a feature point extraction unit 130, a registration unit 140, and an authentication unit 150. The face information DB 110 stores a user ID 111 and face feature information 112 of the user ID in association with each other. The face feature information 112 is a set of feature points extracted from a facial image. The authentication apparatus 100 may delete face feature information 112 in the face feature DB 110 in response to a request from a registered user of the face feature information 112. Alternatively, the authentication apparatus 100 may delete face feature information 112 after elapse of a certain period from registration of the face feature information 112.

The face detection unit 120 detects a face area included in a registration image for registration of face information and outputs the face area to the feature point extraction unit 130. The feature point extraction unit 130 extracts a feature point from the face area detected by the face detection unit 120 and outputs face feature information to the registration unit 140. Further, the feature point extraction unit 130 extracts a feature point included in a facial image received from the value transfer apparatus 200 and outputs face feature information to the authentication unit 150.

The registration unit 140 newly issues a user ID 111 at registration of face feature information. The registration unit 140 registers the issued user ID 111 and face feature information 112 extracted from a registration image in association with each other in the face information DB 110. The authentication unit 150 performs face authentication using face feature information 112. Specifically, the authentication unit 150 checks face feature information extracted from a facial image against face feature information 112 in the face information DB 110. The authentication unit 150 returns match/mismatch of the face feature information to the value transfer apparatus 200. Match/mismatch of the face feature information corresponds to success/failure of authentication. It is assumed that match of face feature information (existence of matching) refers to a degree of matching being predetermined value or greater.

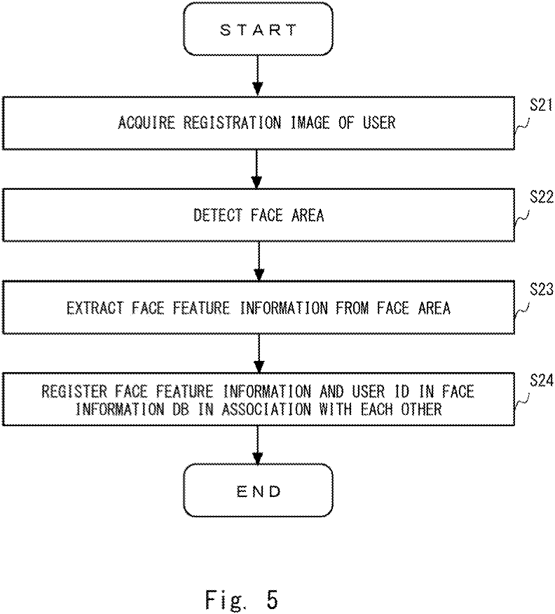

FIG. 5 is a flowchart illustrating a flow of face information registration processing according to the second example embodiment. An information registration terminal (unillustrated) captures an image of a body of each user including the face and transmits a face information registration request including the captured image (registration image) to the authentication apparatus 100 through the network N. Examples of the information registration terminal include information processing apparatuses such as a personal computer, a smartphone, and a tablet terminal. For example, the information registration terminal may be the face authentication terminal 300.

First, the authentication apparatus 100 acquires a registration image included in the face information registration request (S21). For example, the authentication apparatus 100 accepts the face information registration request from the information registration terminal through the network N. Next, the face detection unit 120 detects a face area included in the registration image (S22). Next, the feature point extraction unit 130 extracts a feature point from the face area detected in Step S22 and outputs face feature information to the registration unit 140 (S23). Finally, the registration unit 140 issues a user ID 111 and registers the user ID 111 and the face feature information 112 in association with each other in the face information DB 110 (S24). The authentication apparatus 100 may receive the face feature information 112 from the information registration terminal and register the information in association with the user ID 111 in the face information DB 110.

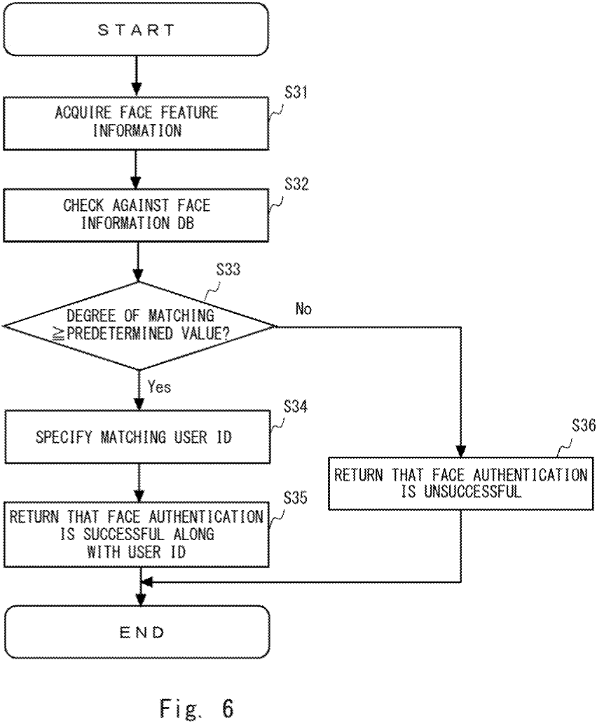

FIG. 6 is a flowchart illustrating a flow of face authentication processing by the authentication apparatus 100 according to the second example embodiment. First, the feature point extraction unit 130 acquires a facial image for authentication included in a face authentication request (S31). For example, the authentication apparatus 100 receives a face authentication request from the value transfer apparatus 200 through the network N and extracts face feature information from a facial image included in the face authentication request, as described in Steps S21 to S23. Alternatively, the authentication apparatus 100 may receive face feature information from the value transfer apparatus 200. Next, the authentication unit 150 checks the acquired face feature information against face feature information 112 in the face information DB 110 (S32). When the pieces of face feature information match, in other words, when a degree of matching between the pieces of face feature information is a predetermined value or greater (Yes in S33), the authentication unit 150 specifies the user ID 111 of a user with the matching face feature information (S34) and returns that face authentication is successful along with the specified user ID 111 to the value transfer apparatus 200 (S35). When matching face feature information does not exist (No in S33), the authentication unit 150 returns that face authentication is unsuccessful to the value transfer apparatus 200 (S36).

Note that the authentication unit 150 does not need to attempt to perform checking against every piece of face feature information 112 in the face information DB 110 in Step S32. For example, the authentication unit 150 may preferentially attempt to perform checking against face feature information registration of which is performed in a period between the day a face authentication request is accepted and several days earlier. Thus, checking speed may be improved. Further, when the aforementioned preferential checking is unsuccessful, checking may be performed against every remaining piece of face feature information.

The description returns to FIG. 3 and is continued. The face authentication terminal 300 is an information processing apparatus including an image capture device and an input-output device such as a touch panel and is an example of an external terminal. The face authentication terminal 300 may be a user terminal being an information terminal carried by a user U1. When the face authentication terminal 300 is the aforementioned information registration terminal, the face authentication terminal 300 individually captures registration images used for face authentication of users U1 and U2. The face authentication terminal 300 transmits a face information registration request including the registration images to the authentication apparatus 100 through the network N. The users U1 and U2 may capture registration images by using another information terminal and perform face information registration. The face authentication terminal 300 may set an image in which the users U1 and U2 are captured together as a registration image. In that case, the face authentication terminal 300 may extract a face area of each user from the registration image and set each face area as a registration image. Alternatively, the face authentication terminal 300 may transmit a face information registration request including one registration image including a plurality of users. In that case, the authentication apparatus 100 extracts a face area of each user from the received registration image and performs face information registration for each face area.

Further, the face authentication terminal 300 captures facial images for authentication used for face authentication of the users U1 and U2. The face authentication terminal 300 transmits a face authentication request including the images for authentication to the value transfer apparatus 200 through the network N. Then, the face authentication terminal 300 receives a list of users face authentication of whom is successful from the value transfer apparatus 200 through the network N and displays the list on a screen. Next, the face authentication terminal 300 accepts selection of a transfer source user and a transfer destination user and input of a transferred portion of points (the number of transferred points) through operation by the user U1 or U2 and transmits a transfer request including information indicating the transfer source user and the transfer destination user, and the number of transferred points. Then, the face authentication terminal 300 receives a transfer result from the value transfer apparatus 200 through the network N and displays the result on the screen.

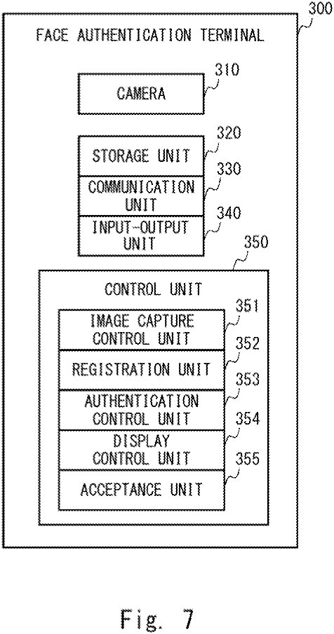

FIG. 7 is a block diagram illustrating a configuration of the face authentication terminal 300 according to the second example embodiment. The face authentication terminal 300 includes a camera 310, a storage unit 320, a communication unit 330, an input-output unit 340, and a control unit 350. The camera 310 is an image capture device for capturing an image in accordance with control by the control unit 350. The storage unit 320 is a storage device for storing a program for providing functions of the face authentication terminal 300. The communication unit 330 is a communication interface with the network N. The input-output unit 340 includes a display device (display unit) such as a screen, and an input device. For example, the input-output unit 340 may be a touch panel. The control unit 350 controls hardware included in the face authentication terminal 300. The control unit 350 includes an image capture control unit 351, a registration unit 352, an authentication control unit 353, a display control unit 354, and an acceptance unit 355.

The image capture control unit 351 controls the camera 310 and captures individual registration images of the users U1 and U2 or an image for authentication including the users U1 and U2. Each of the registration image and the image for authentication is an image including at least a face area of each user. The image capture control unit 351 outputs the registration images to the registration unit 352. Further, the image capture control unit 351 outputs the image for authentication to the authentication control unit 353.

The registration unit 352 transmits a face information registration request including the registration images to the authentication apparatus 100 through the network N. The authentication control unit 353 transmits a face authentication request including the image for authentication to the value transfer apparatus 200 through the network N. The display control unit 354 receives various types of screen data from the value transfer apparatus 200 through the network N and displays the received screen data to the input-output unit 340. The acceptance unit 355 accepts operation on the input-output unit 340 by the user U1 or U2 and transmits operation information corresponding to the accepted operation to the value transfer apparatus 200 through the network N.

The description returns to FIG. 3 and is continued. The value transfer apparatus 200 controls face authentication of the users U1 and U2 included in a captured image captured by the face authentication terminal 300, generates a list of users face authentication of whom is successful, and outputs the list to the face authentication terminal 300. Further, the value transfer apparatus 200 accepts, from the face authentication terminal 300, selection of a transfer source user and a transfer destination user from the list, and input of the number of transferred points. Then, the value transfer apparatus 200 performs control of transferring points for the number of transferred points from the transfer source to the transfer destination. The value transfer apparatus 200 may be provided with redundancy by a plurality of servers, or each functional block may be provided by a plurality of computers.

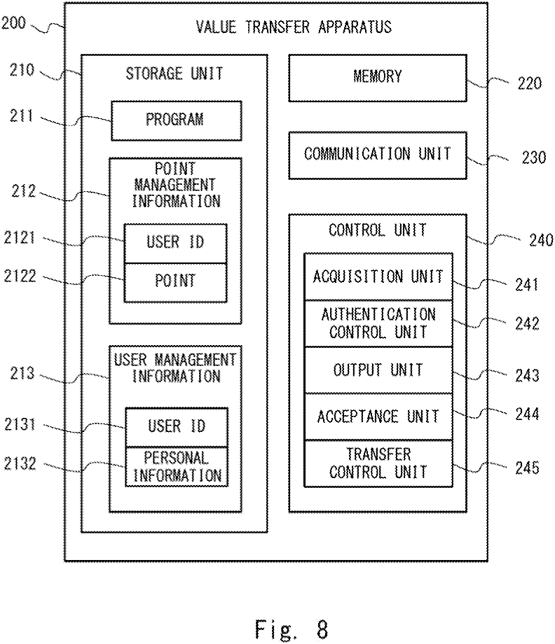

Next, the value transfer apparatus 200 will be described in detail. FIG. 8 is a block diagram illustrating a configuration of the value transfer apparatus 200 according to the second example embodiment. The value transfer apparatus 200 includes a storage unit 210, a memory 220, a communication unit 230, and a control unit 240. The storage unit 210 is a storage device such as a hard disk or a flash memory. The storage unit 210 stores a program 211, point management information 212, and user management information 213. The program 211 is an example of a value transfer program and is a computer program in which processing in a value transfer method according to the second example embodiment is implemented.

The point management information 212 is information for managing a “point” being an example of electronic value information and a user holding the point in association with each other. A point has a pseudo-monetary value exchangeable for a product and/or a service. Value information may be an electronic coupon, electronic money, crypto assets, or an electronic ticket, other than a point. In other words, value information is electronic data indicating an economical value and includes electronic data with a monetary value equivalent to currency and electronic data with a pseudo-monetary value. The point management information 212 associates a user ID 2121 with a point 2122. The user ID 2121 is an example of identification information of a user. For example, the point 2122 is numeric value information.

The user management information 213 is information for managing personal information of a user. The user management information 213 is information associating a user ID 2131 with personal information 2132. The personal information 2132 is a name, a nickname, an address, a phone number, a facial image, and/or the like of an associated user ID 2131.

The memory 220 is a volatile storage device such as a random-access memory (RAM) and is a storage area for temporarily keeping information during operation of the control unit 240. The communication unit 230 is a communication interface with the network N.

The control unit 240 is a processor for controlling components in the value transfer apparatus 200, that is, a control device. The control unit 240 causes the program 211 to be read into the memory 220 from the storage unit 210 and executes the program 211. Thus, the control unit 240 provides functions of an acquisition unit 241, an authentication control unit 242, an output unit 243, an acceptance unit 244, and a transfer control unit 245.

The acquisition unit 241 is an example of the aforementioned acquisition unit 11. The acquisition unit 241 receives a face authentication request from the face authentication terminal 300 through the network N, acquires a captured image included in the face authentication request, and outputs the acquired captured image to the authentication control unit 242.

The authentication control unit 242 is an example of the aforementioned authentication control unit 12. The authentication control unit 242 controls face authentication of face feature information of the users U1 and U2 extracted from a captured image. The authentication control unit 242 causes the authentication apparatus 100 to perform face authentication of face feature information for each user here. Specifically, the authentication control unit 242 specifies face areas of the users U1 and U2 from a captured image acquired by the acquisition unit 241 and extracts face feature information from each face area. Then, the authentication control unit 242 transmits a face authentication request including the face feature information extracted for each user to the authentication apparatus 100 through the network N and receives a face authentication result from the authentication apparatus 100. The authentication control unit 242 may detect face areas of the users U1 and U2 from the captured image and transmit a face authentication request including images of the face areas.

The output unit 243 is an example of the aforementioned output unit 13. The output unit 243 outputs a list of two or more users face authentication of whom is successful to the face authentication terminal 300. Further, the output unit 243 acquires points associated with each user face authentication of whom is successful. Furthermore, the output unit 243 acquires personal information of each user in the list. Then, the output unit 243 outputs the acquired points and the acquired personal information to the face authentication terminal 300 along with the list.

The acceptance unit 244 is an example of the aforementioned acceptance unit 14. The acceptance unit 244 accepts, from the face authentication terminal 300, selection of a transfer source user and a transfer destination user of points from the list and input of the number of transferred points of points. In particular, the acceptance unit 244 accepts input of the number of transferred points from the face authentication terminal 300 after output of points by the output unit 243. In other words, a user operating the face authentication terminal 300 can input the number of transferred points after confirming points held by each user in the list. Accordingly, suitable input can be supported.

The transfer control unit 245 is an example of the aforementioned transfer control unit 15. The transfer control unit 245 performs transfer control of points for the number of transferred points from a transfer source user to a transfer destination user. Specifically, the transfer control unit 245 performs transfer control by changing association of the point management information 212 in the storage unit 210 for the transferred portion from the transfer source user ID to the transfer destination user ID.

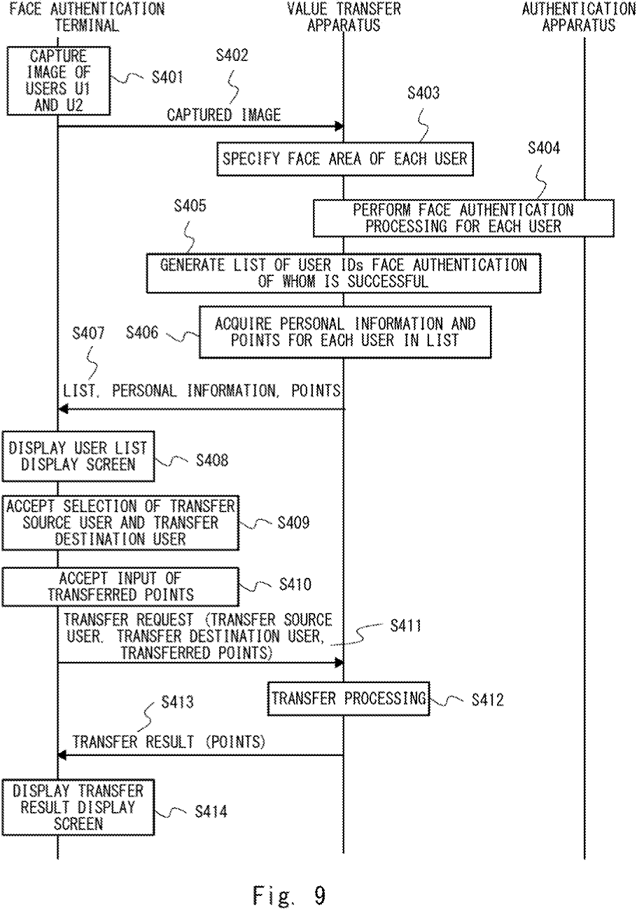

FIG. 9 is a sequence diagram illustrating a flow of value transfer processing according to the second example embodiment. First, the face authentication terminal 300 captures an image of the users U1 and U2 (S401). Then, the face authentication terminal 300 transmits the captured image to the value transfer apparatus 200 through the network N (S403). In response, the acquisition unit 241 in the value transfer apparatus 200 acquires the captured image by receiving the image.

Next, the authentication control unit 242 specifies a face area of each user from the captured image (S403). The authentication control unit 242 specifies a face area of the user U1 and a face area of the user U2 in the captured image here. Then, the authentication control unit 242 extracts face feature information from each specified face area. Specifically, the authentication control unit 242 extracts face feature information f1 of the user U1 and face feature information f2 of the user U2.

Next, the authentication control unit 242 performs face authentication processing for each user (S404). For example, the authentication control unit 242 transmits a face authentication request r1 including the face feature information f1 of the user U1 to the authentication apparatus 100 through the network N. The authentication apparatus 100 performs face authentication of the face feature information f1 included in the face authentication request r1 received from the value transfer apparatus 200 by checking against face feature information 112 in the face information DB 110. It is assumed here that the face authentication is successful. At this time, the authentication apparatus 100 specifies a user ID 111 (that is, a user ID of the user U1) face authentication of whom is successful and includes that face authentication of whom is successful along with the specified user ID 111 in a face authentication result. Then, the authentication apparatus 100 transmits the face authentication result to the value transfer apparatus 200 through the network N. The value transfer apparatus 200 confirms success/failure of the face authentication result received from the authentication apparatus 100 and when the face authentication result indicates success, specifies the user ID included in the face authentication result. In other words, the value transfer apparatus 200 determines that the face authentication of the user U1 is successful.

Next, the authentication control unit 242 transmits a face authentication request r2 including the face feature information f2 of the user U2 to the authentication apparatus 100 through the network N. The authentication apparatus 100 performs face authentication similarly to the above. It is assumed here that the face authentication of the user U2 is successful. Specifically, a face authentication result includes the user ID of the user U2. The authentication apparatus 100 transmits the face authentication result to the value transfer apparatus 200 through the network N. The value transfer apparatus 200 confirms success/failure of the face authentication result received from the authentication apparatus 100 and determines that the face authentication of the user U2 is successful.

Subsequently, the output unit 243 generates a list of user IDs face authentication of whom is successful (S405). Specifically, the output unit 243 acquires a user ID from each face authentication result and generates a list by putting the acquired user IDs together.

Then, the output unit 243 acquires personal information and held points in the generated list (S406). Specifically, the output unit 243 acquires personal information 2132 associated with a user ID 2131 of each of the users U1 and U2 from the user management information 213. Further, the output unit 243 acquires a point 2122 associated with the user ID 2121 of each of the users U1 and U2 from the point management information 212.

Subsequently, the output unit 243 transmits the acquired personal information, the acquired points, and the aforementioned list to the face authentication terminal 300 through the network N (S407). For example, the output unit 243 generates data of a user list display screen, based on the acquired personal information, the acquired points, and the list, and transmits the generated screen data.

The face authentication terminal 300 displays the user list display screen, based on the information received from the value transfer apparatus 200 (S408). The face authentication terminal 300 may generate the user list display screen from the received information or may receive screen data of the user list display screen themselves.

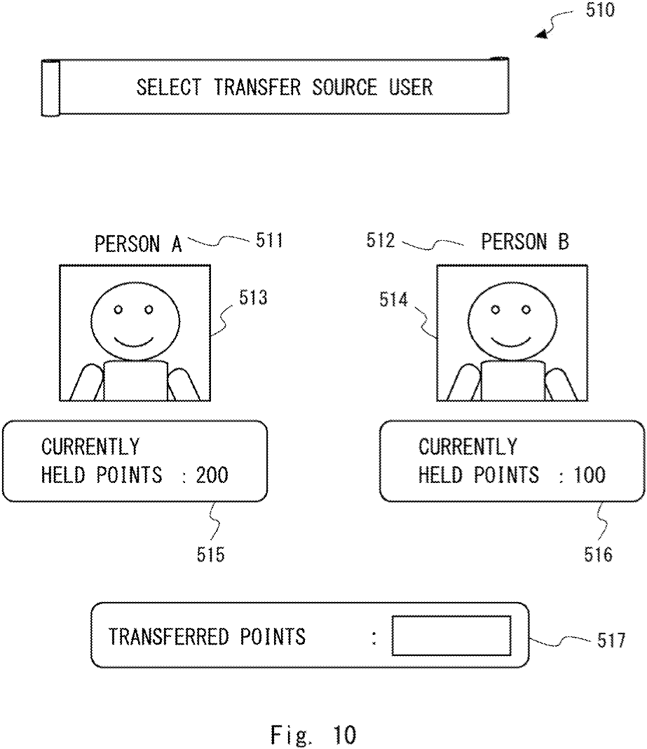

FIG. 10 is a diagram illustrating an example of a user list display screen 510 according to the second example embodiment. Each of username display fields 511 and 512 is a field for displaying a username as personal information of each user. The diagram indicates that a username “A” of the user U1 is displayed in the username display field 511 and that a username “B” of the user U2 is displayed in the username display field 512. Each of facial images 513 and 514 is an image of a body area of each user including the face. The diagram indicates that a facial image of the user U1 is displayed as the facial image 513 and that a facial image of the user U2 is displayed as the facial image 514. Each of held points display field 515 and 516 is a field for displaying the number of points held by each user. The diagram indicates that the held points display field 515 indicates that the user U1 holds 200 points and that the held points display field 516 indicates that the user U2 holds 100 points. A transferred points input field 517 is a field for inputting the number of transferred points transferred by a transfer source user. While the diagram indicates that there is no input at this point in time (before a transfer source user is selected), input may be made. Further, input or change to the transferred points input field 517 may be made after selection of a transfer source user or after selection of a transfer destination user.

Then, the face authentication terminal 300 accepts selection of a transfer source user and a transfer destination user from the user U1 (S409). First, a message “SELECT TRANSFER SOURCE USER” is displayed in the user list display screen 510. Then, it is assumed that the user U1 selects the facial image 513 of the user U1. In other words, the face authentication terminal 300 accepts selection of the user U1 as a transfer source user from the user U1.

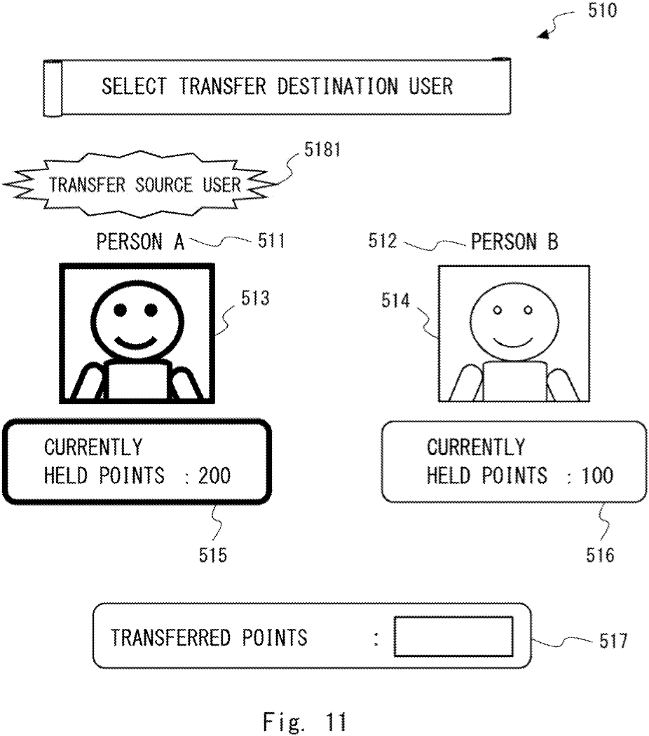

FIG. 11 is a diagram illustrating a selection example of a transfer source user according to the second example embodiment. In response to selection of the facial image 513, the face authentication terminal 300 displays a transfer source user display 5181 above the username display field 511, displays the facial image 513 and the held points display field 515 in thick lines, and displays a message “SELECT TRANSFER DESTINATION USER.” Then, it is assumed that the user U1 selects the facial image 514 of the user U2. In other words, the face authentication terminal 300 accepts selection of the user U2 as a transfer destination user from the user U1.

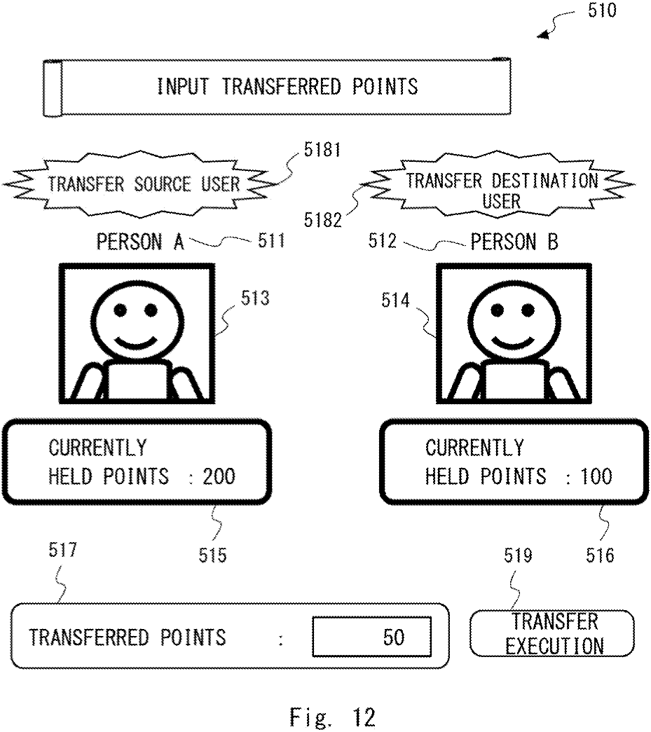

Next, the face authentication terminal 300 accepts input of transferred points from the user U1 (S410). FIG. 12 is a diagram illustrating a selection example of a transfer destination user and a transferred points input example, according to the second example embodiment. In response to selection of the facial image 514, the face authentication terminal 300 displays a transfer destination user display 5182 above the username display field 512, displays the facial image 514 and the held points display field 516 in thick lines, and displays a message “INPUT TRANSFERRED POINTS.” Then, it is assumed that the user U1 inputs “50” to the transferred points input field 517. In other words, the face authentication terminal 300 accepts input of “50” as the number of transferred points from the user U1. At this time, the face authentication terminal 300 displays a transfer execution button 519 in the user list display screen 510. When the transfer execution button 519 is depressed, a transfer request is transmitted.

Then, it is assumed that the user U1 depresses the transfer execution button 519. At this time, the face authentication terminal 300 transmits a transfer request including the transfer source user ID and the transfer destination user ID that are selected on the user list display screen 510 and the input number of transferred points to the value transfer apparatus 200 through the network N (S411).

The acceptance unit 244 in the value transfer apparatus 200 receives the transfer request from the face authentication terminal 300 and acquires the transfer source user ID, the transfer destination user ID, and the input number of transferred points that are included in the transfer request. The acceptance unit 244 accepts the user U1 and the user U2 as a selected transfer source and a selected transfer destination, respectively. Further, the acceptance unit 244 accepts “50” as the input number of transferred points.

Then, the transfer control unit 245 performs transfer processing (S412). Specifically, the transfer control unit 245 performs an update by subtracting the number of transferred points “50” from the point 2122 “200” associated with the user ID 2121 of the user U1 (person A) being the transfer source user in the point management information 212. Therefore, the held points of the person A after the update becomes “150.”. Further, the transfer control unit 245 performs an update by adding the number of transferred points “50” to the point 2122 “100” associated with the user ID 2121 of the person B being the transfer destination user in the point management information 212. Therefore, the held points of the person B after the update becomes “150.”

The output unit 243 transmits a transfer result including the held points and the number of transferred points of the transfer source user and the transfer destination user after the update to the face authentication terminal 300 through the network N (S413). For example, the output unit 243 generates data of a transfer result display screen, based on the held points and the number of transferred points after the update, the personal information and the facial images of the transfer source user and the transfer destination user and transmits the generated screen data.

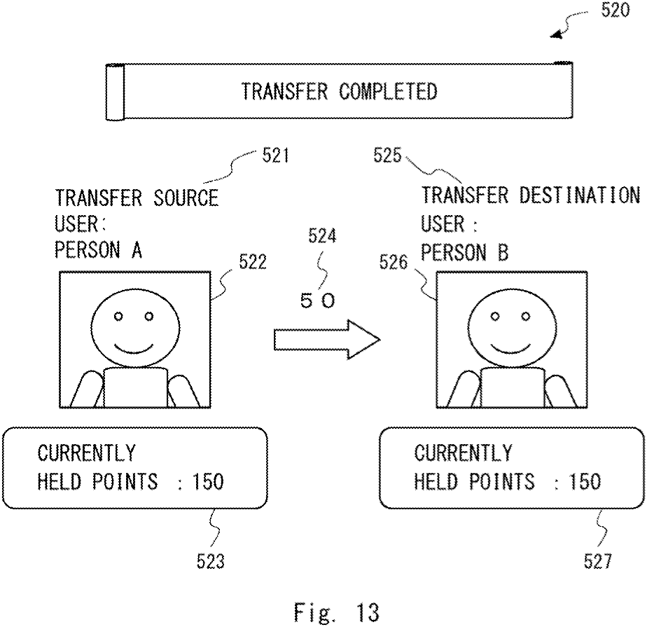

The face authentication terminal 300 displays a transfer result display screen, based on the transfer result received from the value transfer apparatus 200 (S414). The face authentication terminal 300 may generate the transfer result display screen from the received transfer result or may receive screen data of the transfer result display screen themselves. FIG. 13 is a diagram illustrating an example of a transfer result display screen 520 according to the second example embodiment. A username display field 521 and a facial image 522 indicate that the username and a facial image of the user U1 being a transfer source user are displayed, respectively. A held points display field 523 is a field for displaying the number of points held by the transfer source user after the transfer (after the update). The diagram indicates that the person A (user U1) holds 150 points. A username display field 525 and a facial image 526 indicate that the username and a facial image of the user U2 being a transfer destination user are displayed, respectively. A held points display field 527 is a field for displaying the number of points held by the transfer destination user after the transfer (after the update). The diagram indicates that the person B (user U2) holds 150 points. A transferred point 524 is a field for displaying the number of transferred points. The diagram indicates that 50 points are transferred. The value transfer apparatus 200 may transmit the transfer result display screen to a user terminal carried by the transfer destination user and accept consent/rejection of the transfer from the transfer destination user.

Thus, a transfer source and a transfer destination of value information are selected from users face authentication of whom is successful, and an input transferred portion is transferred from the selected transfer source user to the selected transfer destination user, according to the present example embodiment. Listing of users being selection candidates is performed by face authentication based on one-time image capture, and therefore a user related to the transfer can easily select a target user from the list. Then, assignation (transfer) of value information can be smoothly executed. Therefore, a transfer destination user can receive transfer of value information without operation by the user. Accordingly, subsequent use of value information is promoted.

A case of two persons being included in a captured image has been described in the present example embodiment. In that case, after one user is selected as a transfer source user in FIG. 10, the other user being unselected may be assumed to be selected as a transfer destination user without requesting selection of a transfer destination user. For example, a screen for confirming whether a user not selected as a transfer source user in FIG. 10 can be assumed to be a transfer destination may be displayed. Further, after one user is selected as a transfer source user in FIG. 10, a transition to a screen displaying a message “INPUT TRANSFERRED POINTS” as illustrated in FIG. 12 may be made.

Selection operation of a transfer source and a transfer destination according to the present example embodiment may be different from the above. For example, by performing operation of dragging a facial image of a certain user to a facial image of another user in the user list display screen, the user captured in the dragged facial image and the user captured in the facial image being the drag destination may be assumed to be selected as a transfer source and a transfer destination, respectively. Specifically, the output unit 243 may output a first indicator indicating a first user included in the list and a second indicator indicating a second user in such a way that the indicators are displayed on a display unit in the face authentication terminal 300. In that case, when accepting, from the face authentication terminal 300, operation of moving the displayed position of the first indicator to the displayed position of the second indicator, the acceptance unit 244 accepts the first user and the second user as a selected transfer source and a selected transfer destination, respectively. For example, when a facial image of the user U1 is superimposed on a facial image of the user U2 by the drag operation, the user U1 and the user U2 are assumed to be accepted as a transfer source and a transfer destination, respectively. Thus, selection of a transfer source and a transfer destination can be simplified.

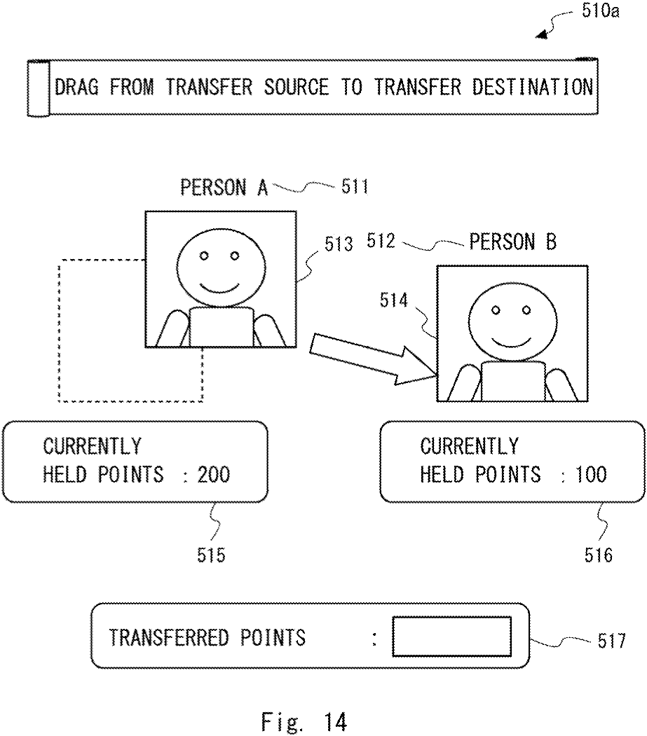

FIG. 14 is a diagram illustrating another selection example of a transfer source and a transfer destination according to the second example embodiment. Differently from the user list display screen 510, a message “DRAG FROM TRANSFER SOURCE TO TRANSFER DESTINATION” is displayed in a user list display screen 510a. Further, it is assumed that a username display field 511 and a facial image 513 are examples of the aforementioned first indicator and that a username display field 512 and a facial image 514 are examples of the aforementioned second indicator.

Then, it is assumed that the user U1 moves the facial image 513 of the user U1 to the facial image 514 of the user U2 by the drag operation. In this case, the face authentication terminal 300 includes the user U1 as a transfer source and the user U2 as a transfer destination in a transfer request. Therefore, the acceptance unit 244 in the value transfer apparatus 200 can accept the user U1 as a transfer source and the user U2 as a transfer destination from the received transfer request. Note that a transfer source and a transfer destination may be selected by operation other than the drag operation. For example, it is assumed that a user corresponding to a location where a finger first touches a screen is selected as a transfer source. Subsequently, the finger is moved along the screen (a facial image of the user selected first does not need to move at this time), and a user at a location where the finger finally leaves the screen may be selected as a transfer destination.

### Third Example Embodiment

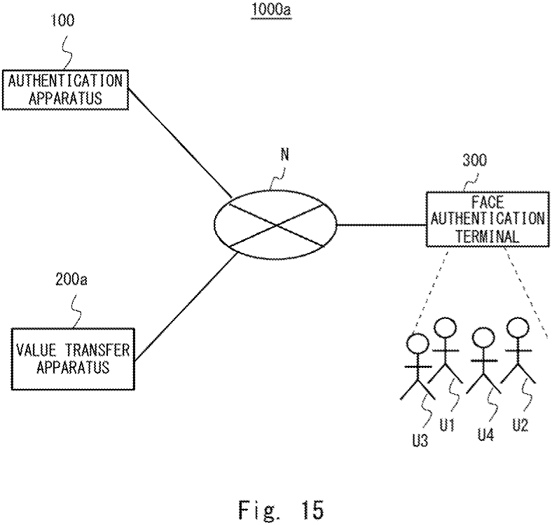

A third example embodiment is a modified example of the aforementioned second example embodiment. An example of transferring value information on an N-to-N basis is described in the third example embodiment. FIG. 15 is a block diagram illustrating an entire configuration of a value transfer system 1000a according to the third example embodiment. Compared with the aforementioned value transfer system 1000, the value transfer system 1000a includes a value transfer apparatus 200a replacing the value transfer apparatus 200. Further, it is assumed that users U1 to U4 exist in front of a face authentication terminal 300. Note that three or more users have only to exist in front of the face authentication terminal 300, according to the third example embodiment. The remaining configuration is equivalent to that of the value transfer system 1000.

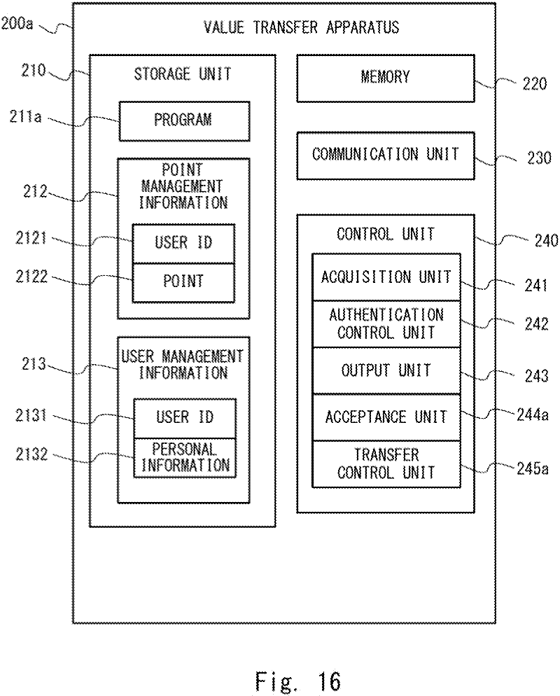

FIG. 16 is a block diagram illustrating a configuration of the value transfer apparatus 200a according to the third example embodiment. Compared with the aforementioned value transfer apparatus 200, the value transfer apparatus 200a includes a program 211a replacing the program 211, and an acceptance unit 244a and a transfer control unit 245a respectively replacing the acceptance unit 244 and the transfer control unit 245. The remaining configuration is equivalent to that of the value transfer apparatus 200.

The program 211a is a computer program in which processing in a value transfer method according to the third example embodiment is implemented. When the number of accepted transfer destination users is two or greater, the acceptance unit 244a accepts input of a received quantity of a transferred portion for each transfer destination user from the face authentication terminal 300. Further, when the number of accepted transfer source users is two or greater, the acceptance unit 244a accepts, from the face authentication terminal 300, each transferred quantity of value information transferred from each transfer source user as input of a transferred portion. The transfer control unit 245a performs transfer control by adding a received quantity corresponding to each transfer destination user to value information associated with the user. Further, the transfer control unit 245a performs the transfer control by subtracting a transferred quantity corresponding to each transfer source user from value information associated with the user.

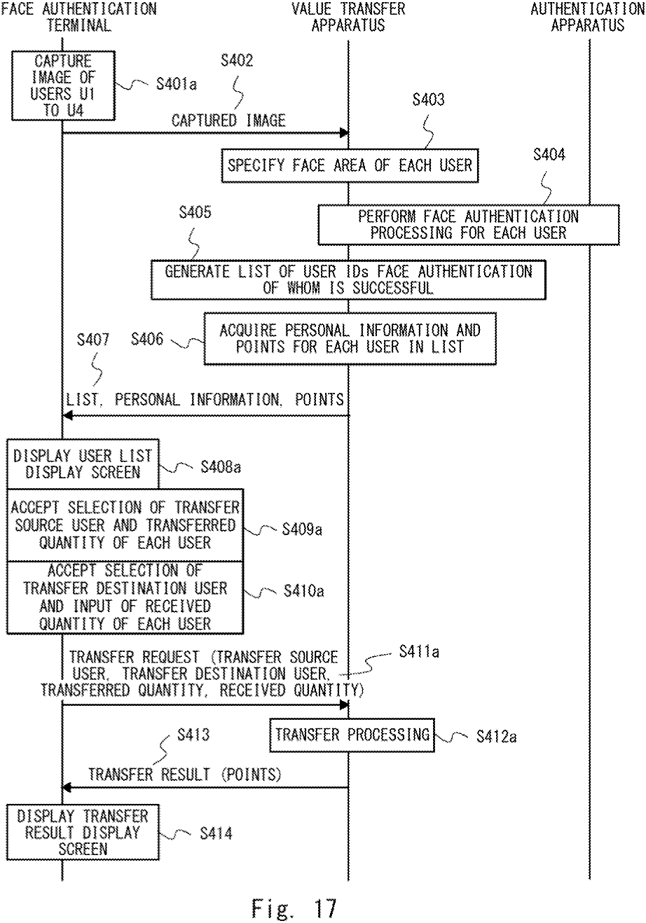

FIG. 17 is a sequence diagram illustrating a flow of value transfer processing according to the third example embodiment. First, the face authentication terminal 300 captures an image of the users U1 to U4 (S401a). Then, the face authentication terminal 300 transmits the captured image to the value transfer apparatus 200a through a network N (S403). In response, an acquisition unit 241 in the value transfer apparatus 200a acquires the captured image by receiving the captured image.

Next, the authentication control unit 242 specifies a face area of each user from the captured image (S403). The authentication control unit 242 specifies a face area of each of the users U1, U2, U3, and U4 in the captured image and extracts face feature information of each user here.

Next, the authentication control unit 242 performs face authentication processing for each user (S404). For example, the authentication control unit 242 transmits four face authentication requests respectively including face feature information of the users to the authentication apparatus 100 through the network N and receives four face authentication results respectively responding to the face authentication requests. Then, the authentication control unit 242 determines success/failure of face authentication for each user. It is assumed here that face authentication of each of the users U1 to U4 is successful.

Subsequently, the output unit 243 generates a list of user IDs face authentication of whom is successful (S405). The list includes user IDs of the users U1 to U4. Then, the output unit 243 acquires personal information and held points in the generated list (S406). Subsequently, the output unit 243 transmits the acquired personal information, the acquired points, and the aforementioned list to the face authentication terminal 300 through the network N (S407). The face authentication terminal 300 displays a user list display screen, based on the information received from the value transfer apparatus 200a (S408a).

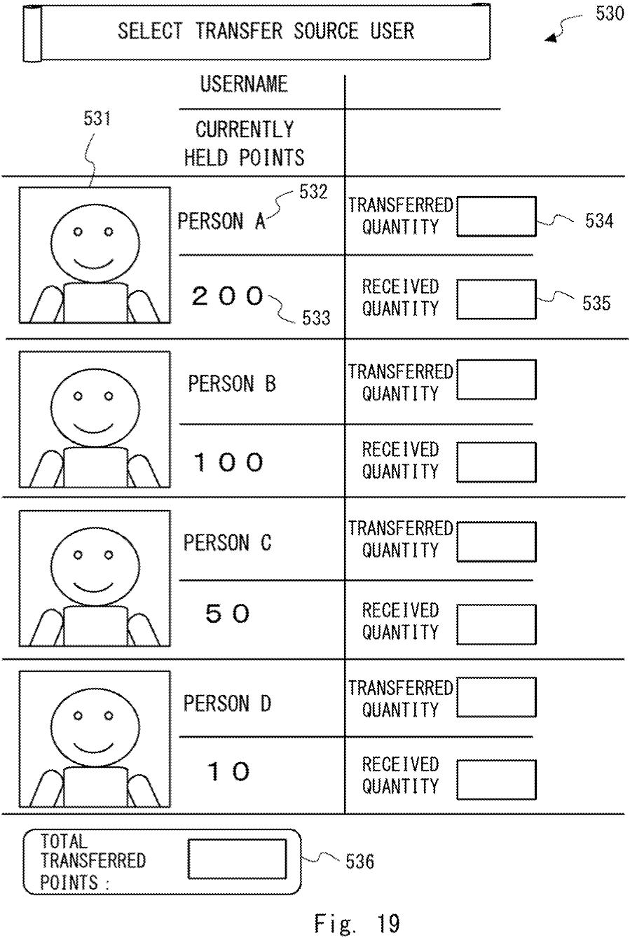

FIG. 19 is a diagram illustrating an example of a user list display screen 530 according to the third example embodiment. A facial image 531 indicates that a facial image corresponding to each of the users U1 to U4 is displayed. A username display field 532 is a field for displaying a username as personal information of each user. The diagram indicates that a username “A” of the user U1, a username “B” of the user U2, a username “C” of the user U3, and a username “D” of the user U4 are displayed. A held points display field 533 is a field for displaying the number of points held by each user. The diagram indicates that the user U1, the user U2, the user U3, and the user U4 respectively hold “200,” “100,” “50,” and “10” points. A transferred quantity input field 534 is a field for inputting the number of transferred points out of held points when being selected as a transfer source user. A received quantity input field 535 is a field for inputting the number of points to be received when being selected as a transfer destination user. A total transferred points display field 536 is a field for displaying the total value of the transferred quantity input fields 534. The transferred quantity input field 534 and the received quantity input field 535 may be placed closer to the facial image 531.

Then, the face authentication terminal 300 accepts selection of a transfer source user and input of a transferred quantity of each user from the user U1 (S409a). First, a message “SELECT TRANSFER SOURCE USER” is displayed in the user list display screen 530. Then, it is assumed that the user U1 selects the facial images 531 of the users U1 and U2. In other words, the face authentication terminal 300 accepts selection of the users U1 and U2 as transfer source users from the user U1. Alternatively, the user U1 may set a facial image enclosed in a circle drawn by a finger in the user list display screen 530 as a transfer source user. Then, when selecting a plurality of transfer source users, the user U1 may depress a button indicating transfer source selection completion when selection of all transfer source users is completed. In that case, the user U1 may set an unselected user in the user list displayed in the user list display screen 530 as a transfer destination user. Subsequently, it is assumed that the user U1 inputs “80” to the transferred quantity input field 534 of the user U1 and “20” to the transferred quantity input field 534 of the user U2. In other words, the face authentication terminal 300 accepts input of a transferred quantity of each of the users U1 and U2 from the user U1.

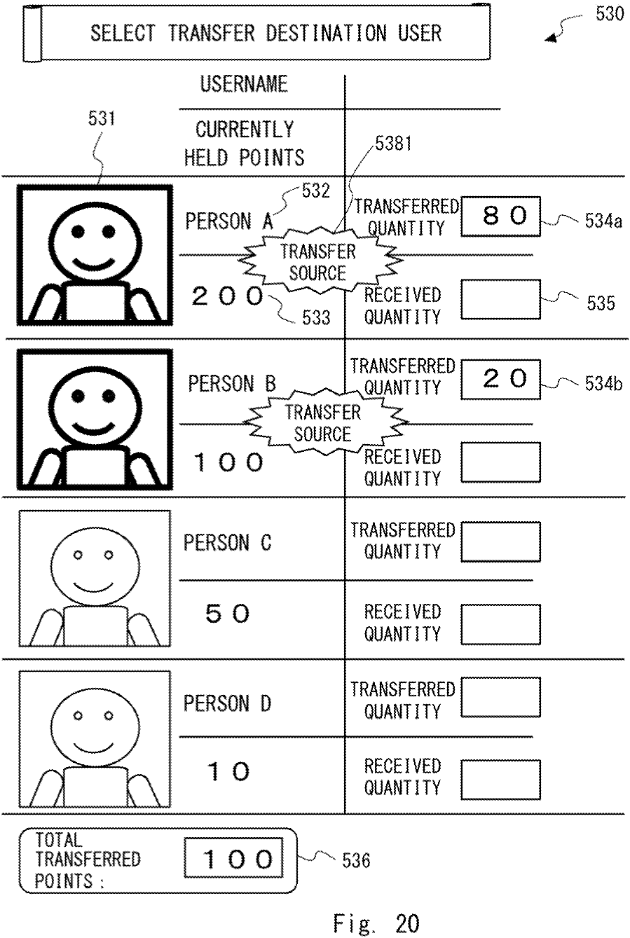

FIG. 20 is a diagram illustrating a selection example of a transfer source user and an input example of a transferred quantity, according to the third example embodiment. In response to selection of the facial images 531 of the users U1 and U2, the face authentication terminal 300 displays the corresponding facial images 531 in thick lines. At this time, the face authentication terminal 300 additionally displays transfer source user displays 5381 near the username display fields 532 or the held points display fields 533 of the users U1 and U2. Then, in response to input of the aforementioned transferred quantities, the face authentication terminal 300 displays “80” in a transferred quantity 534a of the user U1, “20” in a transferred quantity 534b of the user U2, and “100” being the total of the transferred quantities in the total transferred points display field 536. Subsequently, the face authentication terminal 300 displays a message “SELECT TRANSFER DESTINATION USER.”

Then, the face authentication terminal 300 accepts selection of a transfer destination user and input of a received quantity of each user from the user U1 (S410a). At this time, it is assumed that the user U1 selects the facial images 531 of the users U3 and U4. In other words, the face authentication terminal 300 accepts selection of the users U3 and U4 as transfer destination users from the user U1. Subsequently, it is assumed that the user U1 inputs “30” in the received quantity input field 535 of the user U3 and “70” in the received quantity input field 535 of the user U4. In other words, the face authentication terminal 300 accepts input of a transferred quantity of each of the users U3 and U4 from the user U1.

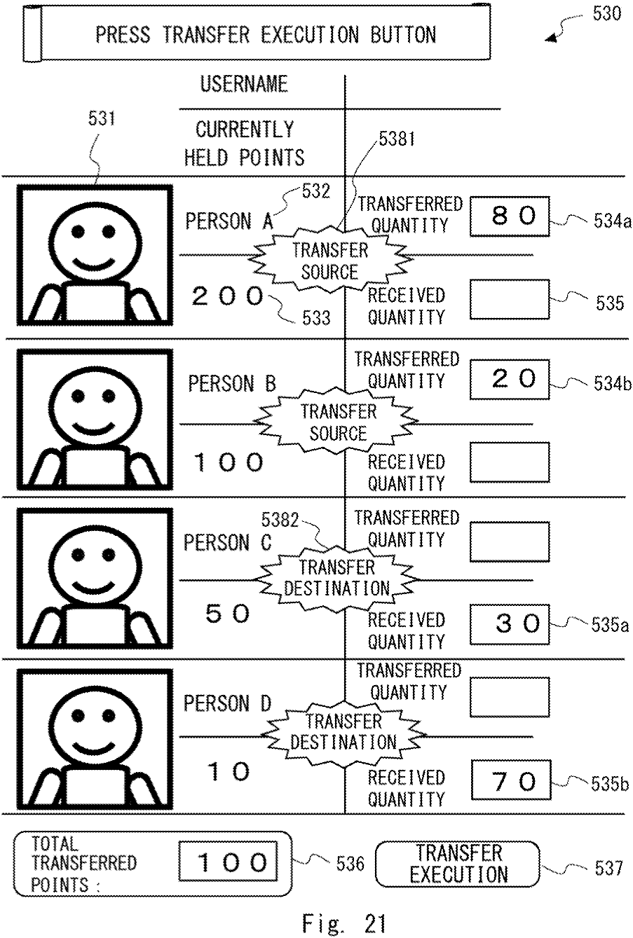

FIG. 21 is a diagram illustrating a selection example of a transfer destination user and an input example of a received quantity, according to the third example embodiment. In response to selection of the facial images 531 of the users U3 and U4, the face authentication terminal 300 displays the corresponding facial images 531 in thick lines. At this time, the face authentication terminal 300 additionally displays transfer destination user displays 5382 near the username display fields 532 or the held points display fields 533 of the users U3 and U4. Then, in response to input of the aforementioned received quantities, the face authentication terminal 300 displays “30” in a received quantity 535a of the user U3 and “70” in a received quantity 535b of the user U4. Subsequently, when the total values of the received quantities 535a and 535b matches the value of the total transferred points display field 536, the face authentication terminal 300 displays a transfer execution button 537 and displays a message “PRESS TRANSFER EXECUTION BUTTON.” When the transfer execution button 537 is depressed, a transfer request is transmitted. When the total value of the received quantities 535a and 535b differs from the value of the total transferred points display field 536, the transfer execution button 537 is not displayed. Further, an input value of the transferred quantity may be adjusted after input of the received quantities.

Then, it is assumed that the user U1 depresses the transfer execution button 537. At this time, the face authentication terminal 300 transmits a transfer request including the transfer source user ID and the transfer destination user ID that are selected on the user list display screen 530, and the transferred quantity and the received quantity of each user to the value transfer apparatus 200 through the network N (S411a).

The acceptance unit 244a in the value transfer apparatus 200a receives the transfer request from the face authentication terminal 300 and acquires the transfer source user ID and the transfer destination user ID, and the transferred quantity and the received quantity of each user that are included in the transfer request. Then, the transfer control unit 245a performs transfer processing (S412a).

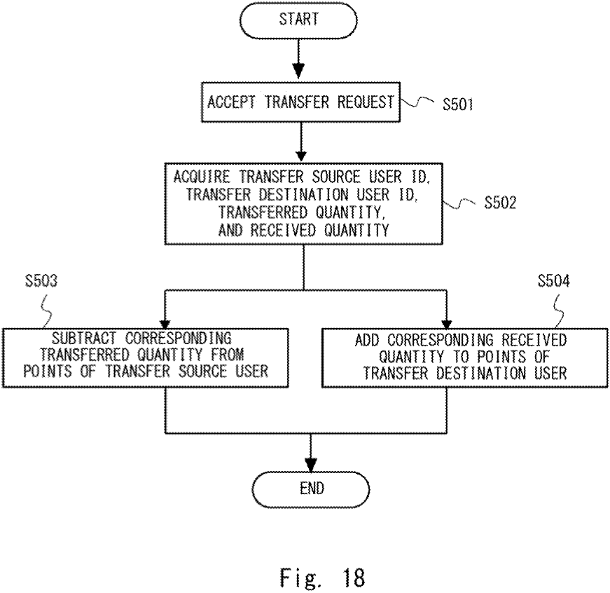

FIG. 18 is a flowchart illustrating a flow of the transfer processing according to the third example embodiment. First, as described above, the acceptance unit 244a accepts a transfer request by receiving the request from the face authentication terminal 300 through the network N (S501). Next, the acceptance unit 244a acquires a transfer source user ID and a transfer destination user ID, and a transferred quantity and a received quantity from the transfer request (S502). The acceptance unit 244a accepts the users U1 and U2 as selected transfer sources, and the users U3 and U4 as selected transfer destinations here. Further, the acceptance unit 244a accepts “80” as an input transferred quantity of the user U1, “20” as an input transferred quantity of the user U2, “30” as an input received quantity of the user U3, and “70” as an input received quantity of the user U4.

Then, the transfer control unit 245a subtracts the corresponding transferred quantity from points of the transfer source user (S503). Specifically, the transfer control unit 245a performs an update by subtracting the transferred quantity “80” from the point 2122 “200” associated with the user ID 2121 of the user U1 (person A) being a transfer source user in the point management information 212. Therefore, the held points of the person A after the update becomes “120.” Further, the transfer control unit 245a performs an update by subtracting the transferred quantity “20” from the point 2122 “100” associated with the user ID 2121 of the user U2 (person B) being a transfer source user in the point management information 212. Therefore, the held points of the person B after the update becomes “80.”

Further, the transfer control unit 245a adds the corresponding received quantity to points of the transfer destination user (S504). Specifically, the transfer control unit 245a performs an update by adding the received quantity “30” to the point 2122 “50” associated with the user ID 2121 of the person C being a transfer destination user in the point management information 212. Therefore, the held points of the person C after the update becomes “80.” Further, the transfer control unit 245a performs an update by adding the received quantity “70” to the point 2122 “10” associated with the user ID 2121 of the person D being a transfer destination user in the point management information 212. Therefore, the held points of the person D after the update becomes “80.”

The output unit 243 transmits a transfer result including the held points, the transferred quantities, and the received quantities of the transfer source users and the transfer destination users after the update to the face authentication terminal 300 through the network N (S413). For example, the output unit 243 generates data of a transfer result display screen, based on the held points, the transferred quantities, and the received quantities after the update, and personal information and facial images of the transfer source users and the transfer destination users and transmits the generated screen data.

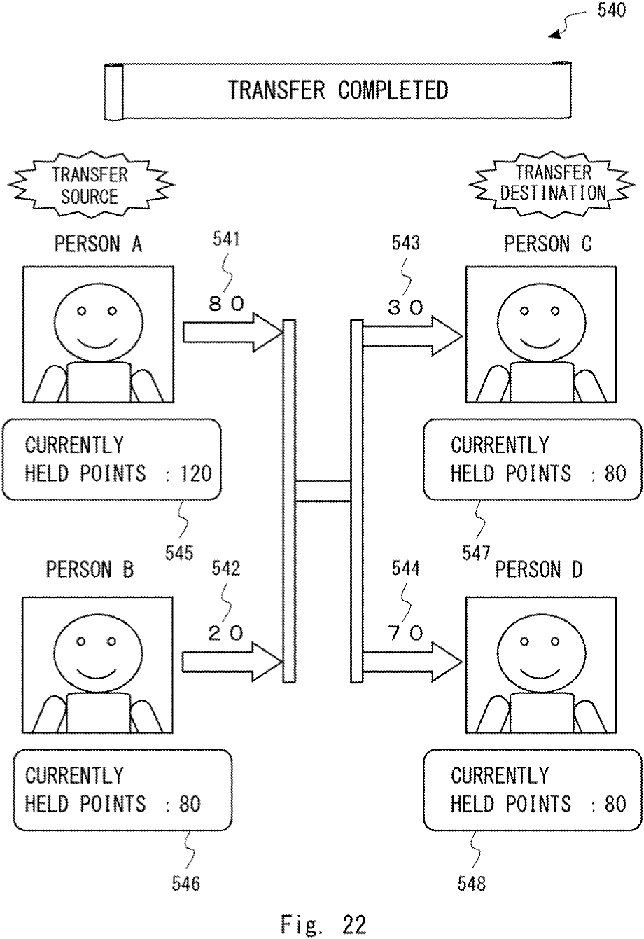

The face authentication terminal 300 displays a transfer result display screen, based on the transfer result received from the value transfer apparatus 200 (S414). FIG. 22 is a diagram illustrating an example of a transfer result display screen 540 according to the third example embodiment. A transferred quantity 541 indicates the number of points transferred from the person A (user U1). A transferred quantity 542 indicates the number of points transferred from the person B (user U2). A received quantity 543 indicates the number of points received by the person C (user U3). A received quantity 544 indicates the number of points received by the person D (user U4). Each of held points display fields 545 and 546 is a field for displaying the number of points held by a transfer source user after a transfer (after an update). The diagram indicates that the person A (user U1) holds 120 points, and the person B (user U2) holds 80 points. Each of held points display fields 547 and 548 is a field for displaying the number of points held by a transfer destination user after the transfer (after the update). The diagram indicates that the person C (user U3) holds 80 points, and the person D (user U4) holds 80 points.

Thus, the present example embodiment enables suitable and easy N-to-N transfer of value information. Note that there may be only one transfer source or transfer destination as long as there are more than one of the other. In other words, it is apparent that the present example embodiment is applicable to one-toN or N-to-one transfer of value information. Thus, value information can be easily circulated among more users compared with the second example embodiment.

### Fourth Example Embodiment

A fourth example embodiment is a modified example of the aforementioned second or third example embodiment. The present example embodiment employs two-factor authentication performing face authentication on a transfer source or a transfer destination in transfer of value information along with another type of authentication. In particular, transfer confirmation to an information terminal carried by a user is performed as the other type of authentication in the fourth example embodiment.

According to the aforementioned second or third example embodiment, all of transfer source users and transfer destination users need to be present in front of the face authentication terminal 300 in order to transfer value information. However, transfer source users and transfer destination users are not necessarily present. Then, when an image of users is captured for face authentication, it is considered to capture an image of a separately captured facial image held to a camera 310 in a face authentication terminal 300. However, transfer may be performed without knowledge of a transfer source or a transfer destination in that case. In particular, a transfer source may be impersonated, and value information may be improperly stolen. Then, corroboration in consent of transfer is enhanced by combining face authentication with another type of authentication, according to the fourth example embodiment. The fourth example embodiment is applicable to either one of a transfer source and a transfer destination.

Part of users and a facial photograph of an absent user may exist in an image capture area of the camera 310. Alternatively, two or more facial photographs may exist in an image capture area of the camera 310. While the present example embodiment is described as a modified example of the second example embodiment, the present example embodiment is similarly applicable to the third example embodiment.

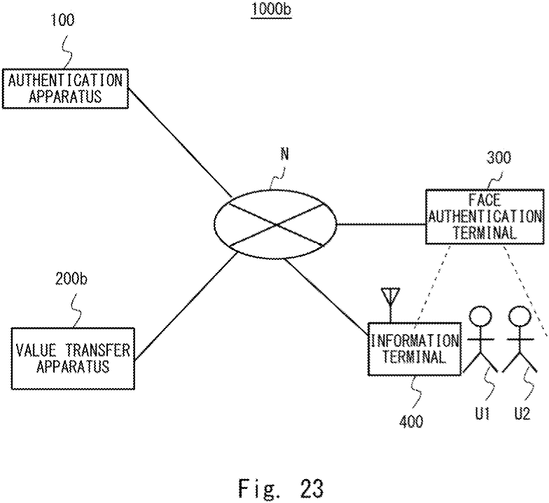

FIG. 23 is a block diagram illustrating an entire configuration of a value transfer system 1000b according to the fourth example embodiment. In the value transfer system 1000b, compared with the aforementioned value transfer system 1000, the value transfer apparatus 200 is replaced by a value transfer apparatus 200b, and an information terminal 400 is added. The remaining configuration is equivalent to that of the value transfer system 1000.

The information terminal 400 is a mobile terminal carried by a user U1, examples of the terminal including a smartphone and a tablet terminal. The information terminal 400 is associated with terminal information for identifying the terminal, such as a phone number. The information terminal 400 is connected to a network N. Therefore, the value transfer apparatus 200b can notify the information terminal 400 of a transfer confirmation message through the network N by using the terminal information. Further, in response to a transfer confirmation message, the information terminal 400 can return a transfer consent or a transfer rejection input from the user U1 to the value transfer apparatus 200b through the network N.

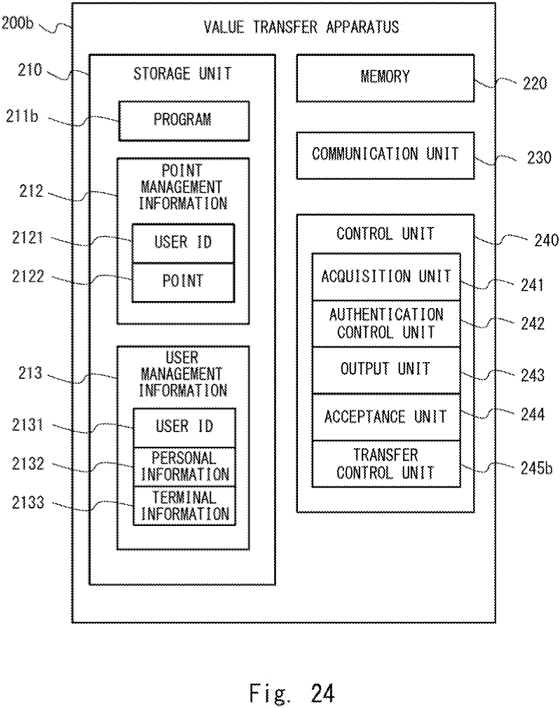

FIG. 24 is a block diagram illustrating a configuration of the value transfer apparatus 200b according to the fourth example embodiment. In a storage unit 210 in the value transfer apparatus 200b, compared with the aforementioned value transfer apparatus 200, the program 211 is replaced by a program 211b, and terminal information 2133 is added to user management information 213. Further, the transfer control unit 245 is replaced by a transfer control unit 245b in a control unit 240 in the value transfer apparatus 200b. The remaining configuration is equivalent to that of the value transfer apparatus 200.

The program 211b is a computer program in which processing in a value transfer method according to the fourth example embodiment is implemented. Terminal information 2133 is information for identifying an information terminal 400, examples of the information including a phone number, an electronic mail address, and an ID for an SNS application. The terminal information 2133 is associated with a user ID 2131.

The transfer control unit 245b transmits a transfer confirmation to an information terminal 400 corresponding to a user selected as a transfer source and when receiving a transfer consent from the information terminal 400, performs transfer control with the user as a transfer source user. Thus, impersonation of a transfer source can be suppressed. Transfer confirmation may be performed on a transfer destination. Specifically, the transfer control unit 245b may transmit a transfer confirmation to an information terminal corresponding to a user selected as a transfer destination and when receiving a transfer consent from the information terminal, may perform transfer control with the user as a transfer destination user.

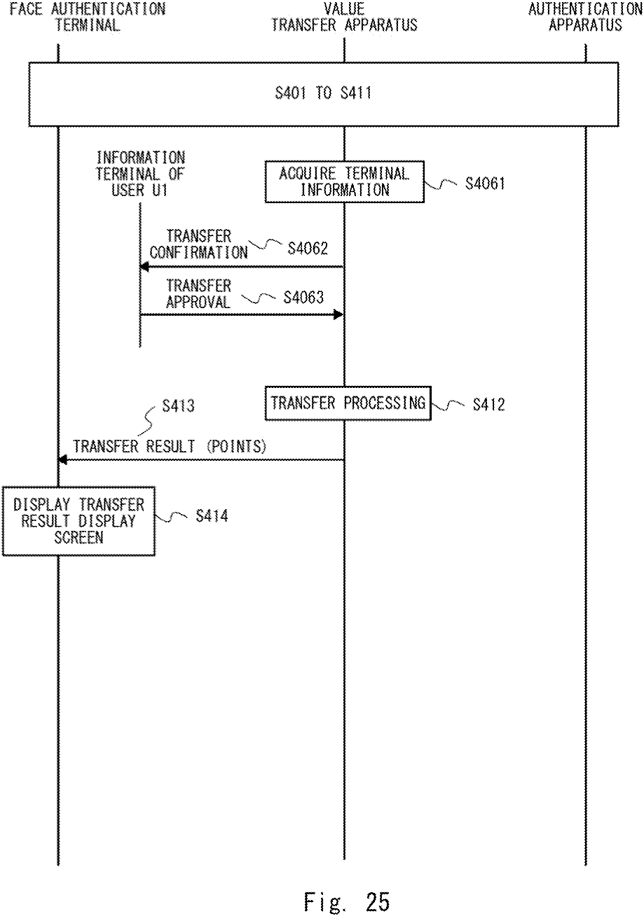

FIG. 25 is a sequence diagram illustrating a flow of value transfer processing according to the fourth example embodiment. First, Step S401 to S411 are similar to those in aforementioned FIG. 9. In response to Step S411, an acceptance unit 244 in the value transfer apparatus 200b receives a transfer request from the face authentication terminal 300 and acquires user IDs of a transfer source and a transfer destination and an input number of transferred points that are included in the transfer request. It is assumed here that the acceptance unit 244 accepts the user U1 as a selected transfer source and a user U2 as a selected transfer destination.

Then, the transfer control unit 245b acquires terminal information corresponding to the accepted users (S4061). The transfer control unit 245b acquires terminal information 2133 associated with the user ID 2131 of the user U1 being a transfer source from the user management information 213 here. The acquired terminal information corresponds to the information terminal 400 carried by the user U1.

The transfer control unit 245b may acquire terminal information 2133 associated with the user ID 2131 of the user U2 being a transfer destination from the user management information 213. Alternatively, the transfer control unit 245b may acquire terminal information corresponding to each of a transfer source user and a transfer destination user.

The transfer control unit 245b transmits a transfer confirmation message with the acquired terminal information as a destination through the network N (S4062). The information terminal 400 displays the received transfer confirmation message and accepts transfer approval through operation by the user U1. Then, the information terminal 400 returns transfer approval to the value transfer apparatus 200b through the network N (S4063). By reception of the transfer approval, the transfer control unit 245b in the value transfer apparatus 200b sets the user U1 as a transfer source user. Next, Steps S412 to S414 are performed similarly to those in aforementioned FIG. 9.

Thus, the present example embodiment can provide two-factor authentication performing face authentication on a transfer source or a transfer destination in transfer of value information along with another type of authentication. Then, performing the two-factor authentication enhances corroboration of transfer approval. For example, even when a transfer source user or a transfer destination user does not exist in front of the face authentication terminal 300 at the time of transfer, easy and secure transfer of value information can be provided by holding a separately captured facial image to a face image for authentication. Further, both a transfer source and a transfer destination user may not exist in front of the face authentication terminal 300, and a third party may transfer value information by using a facial image of the transfer source or the transfer destination.

### Fifth Example Embodiment

A fifth example embodiment is a modified example of the aforementioned fourth example embodiment. The fifth example embodiment performs two-factor authentication performing face authentication on a transfer source or a transfer destination in transfer of value information along with another type of authentication. In particular, input of identification information of a user is requested as the other type of authentication, according to the fifth example embodiment. The fifth example embodiment is applicable to both a transfer source and a transfer destination. An entire configuration and a configuration of a value transfer apparatus according to the fifth example embodiment are equivalent to those in aforementioned FIG. 3 and FIG. 8 except for the following, and therefore illustration and description thereof are omitted.

An acceptance unit 244 according to the fifth example embodiment further accepts input of identification information of a user selected as a transfer destination. For example, the identification information is a user ID but may also be a password or the like. When the identification information is a password or the like, it is assumed that the password or the like is included in personal information 2132.

Further, a transfer control unit 245 according to the fifth example embodiment specifies identification information of a user selected as a transfer destination, based on a result of biometric authentication. Then, when accepted identification information of a user selected as a transfer destination matches the specified identification information, the transfer control unit 245 performs transfer control with the user as a transfer destination user.

Note that the acceptance unit 244 may accept identification information of a transfer source, and the transfer control unit 245 may identify identification information from a biometric authentication result of the transfer source user.

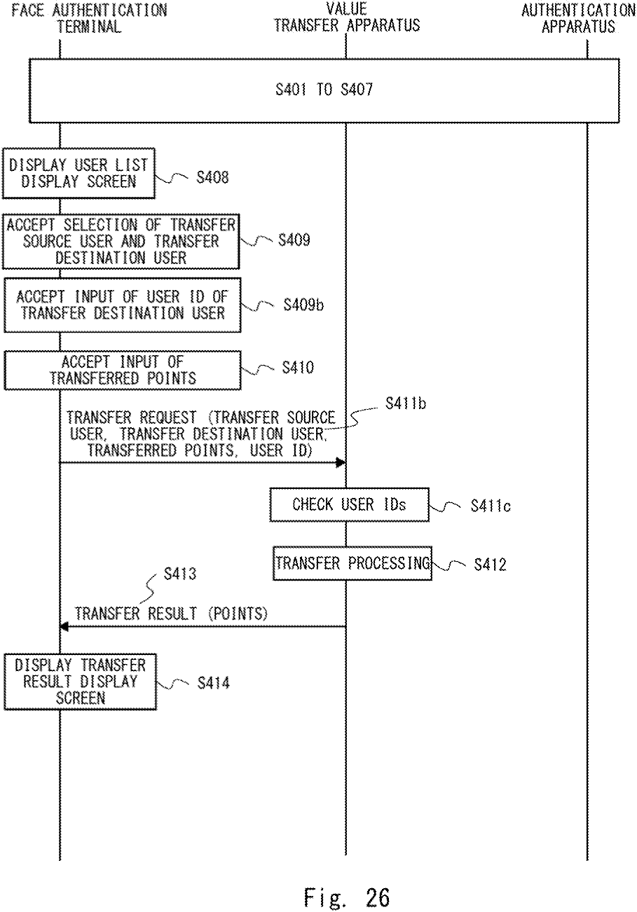

FIG. 26 is a sequence diagram illustrating a flow of value transfer processing according to the fifth example embodiment. First, Steps S401 to S407 are similar to those in aforementioned FIG. 9. After Step S407, a face authentication terminal 300 displays the aforementioned user list display screen (S408) and accepts selection of a transfer source user and a transfer destination user from a user U1 (S409).

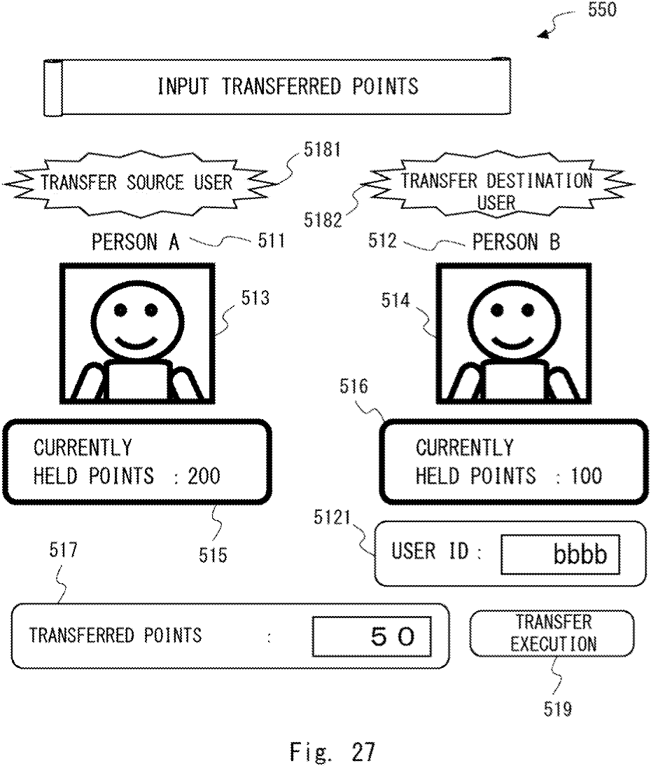

Next, the face authentication terminal 300 accepts input of the user ID of the transfer destination user from the user U1 (S409b). FIG. 27 is a diagram illustrating a selection example of a transfer destination user and an input example of a user ID, according to the fifth example embodiment. Compared with aforementioned FIG. 12, a user ID input field 5121 is additionally displayed in a user list display screen 550. For example, it is assumed that the user ID input field 5121 is displayed after a facial image of a transfer destination is selected by the user U1. The user ID input field 5121 is an input field of the user ID of a transfer destination user. The diagram indicates that a user ID “bbbb” of a person B (user U2) is input.

It is assumed here that the user U1 depresses a transfer execution button 519. At this time, the face authentication terminal 300 includes a user ID input to the user ID input field 5121 in a transfer request in addition to a transfer source user ID and a transfer destination user ID that are selected on the user list display screen 550 and the number of transferred points input on the user list display screen 550. Then, the face authentication terminal 300 transmits the transfer request to a value transfer apparatus 200 through a network N (S411b).

The acceptance unit 244 in the value transfer apparatus 200 receives a transfer request from the face authentication terminal 300 and acquires a transfer source user ID and a transfer destination user ID, an input number of transferred points, and an input transfer destination user ID that are included in the transfer request. The acceptance unit 244 accepts the user U1 as a selected transfer source and the user U2 as a selected transfer destination here. Further, the acceptance unit 244 accepts “50” as an input number of transferred points. Furthermore, the acceptance unit 244 accepts “bbbb” as an input user ID.

Then, the transfer control unit 245 checks the user ID of the user U2 against the input user ID “bbbb,” the user IDs being included in the face authentication result (S411c). Note that the transfer destination user ID included in the transfer request may be used in place of the user ID of the user U2 included in the face authentication result. It is assumed here that the user IDs match. Then, Step S412 and beyond are performed similarly to those in FIG. 9.

Thus, the present example embodiment can also provide effects similar to those of the aforementioned fourth example embodiment.

The two-factor authentication according to the fourth and fifth example embodiments is preferably applied to a case of a face in a captured image being captured from a facial photograph, that is, a case of a facial photograph being determined to be held up by a third party. For example, determination of whether a face in a captured image is captured from a facial photograph can be provided by liveness detection such as motion liveness (whether the face moves in accordance with an instruction), analysis of an image captured by an infrared camera, or determination of whether an eye in a captured dynamic image is moving. Then, when the face in the captured image is determined to be captured from a facial photograph by liveness detection, transfer confirmation to an information terminal according to the fourth example embodiment and checking of an input user ID according to the fifth example embodiment are preferably performed.

The two-factor authentication according to the fourth and fifth example embodiments may be performed not only when a facial photograph is held up but also when the user himself/herself is on the spot and the actual face is captured.

### Sixth Example Embodiment

A sixth example embodiment is a modified example of the aforementioned second to fifth example embodiments. A biometric authentication function is built into a value transfer apparatus according to the sixth example embodiment. While the present example embodiment is described below as a modified example of the second example embodiment, the present example embodiment is similarly applicable to the third to fifth example embodiments. Further, a value transfer system according to the sixth example embodiment is similar to the aforementioned value transfer system 1000, and therefore illustration and description thereof are omitted.

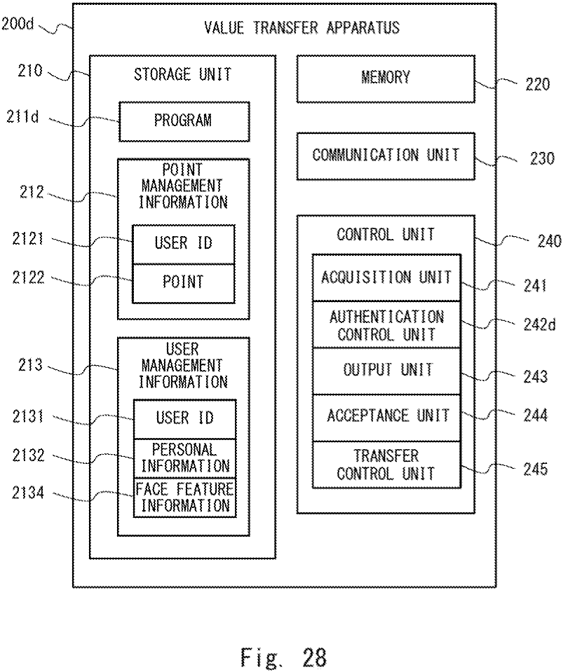

FIG. 28 is a block diagram illustrating a configuration of a value transfer apparatus 200d according to the sixth example embodiment. Compared with the aforementioned value transfer apparatus 200, the program 211 is replaced by a program 211d, and face feature information 2134 is added to a user management information 213 in a storage unit 210 in the value transfer apparatus 200d. Further, compared with the aforementioned value transfer apparatus 200, the authentication control unit 242 is replaced by an authentication control unit 242d in a control unit 240 in the value transfer apparatus 200d.

The program 211d is a computer program in which processing in a value transfer method according to the sixth example embodiment is implemented.

The face feature information 2134 is equivalent to the face feature information 112 according to the aforementioned authentication apparatus 100. The face feature information 2134 is associated with a user ID 2131. Specifically, the user management information 213 includes the aforementioned face information DB 110 and is an example of a biometric information storage means for storing biometric information of a plurality of users.

The authentication control unit 242d performs face authentication by checking face feature information of a user group including a plurality of users against face feature information of each of users U1 and U2. Specifically, the authentication control unit 242d acquires a face authentication result by performing face authentication by checking face feature information extracted from a face area of each user included in an acquired captured image against face feature information 2134 stored in the storage unit 210.

Note that Step S404 in aforementioned FIG. 9 and FIG. 17 is replaced by face authentication processing in the value transfer apparatus 200d by the authentication control unit 242d, according to the present example embodiment.

Thus, the sixth example embodiment can also provide effects similar to those of the aforementioned second example embodiment. It is apparent that the modifications made to the third to fifth example embodiments are also applicable to the sixth example embodiment.

### Other Example Embodiments

While the aforementioned example embodiments have been described as hardware configurations, the example embodiments are not limited thereto. The present disclosure may be provided by performing any type of processing by causing a CPU to execute a computer program.

In the aforementioned example, the program may be stored by using various types of non-transitory computer-readable media and be supplied to the computer. The non-transitory computer-readable media include various types of tangible storage media. Examples of the non-transitory computer-readable medium include magnetic storage media (such as a flexible disk, a magnetic tape, and a hard disk drive), magneto-optical storage media (such as a magneto-optical disk), CD-read-only memory (ROM), a CD-R, a CD-R/W, a digital versatile disc (DVD), and semiconductor memories [such as a mask ROM, a programmable ROM (PROM), an erasable PROM (EPROM), a flash ROM, and a random-access memory (RAM)]. Further, the program may be supplied to the computer by various types of transitory computer-readable media. Examples of the transitory computer-readable medium include an electric signal, an optical signal, and an electromagnetic wave. The transitory computer-readable medium can supply the program to the computer through a wired communication channel such as an electric cable or optical fiber, or a wireless communication channel.

The present disclosure is not limited to the aforementioned example embodiments and may be modified as appropriate without departing from the spirit thereof. Further, the present disclosure may be implemented by combining the example embodiments as appropriate.

Part or the whole of the example embodiments disclosed above may also be described as, but not limited to, the following Supplementary Notes.

### (Supplementary Note E1)

A value transfer apparatus including:
an acquisition means for acquiring a captured image including a plurality of users;
an authentication control means for controlling biometric authentication of biometric information of each of the plurality of users extracted from the captured image;
an output means for outputting a list of two or more users the biometric authentication of whom is successful to an external terminal;
an acceptance means for accepting, from the external terminal, selection of a transfer source user and a transfer destination user of electronic value information from the list and input of a transferred portion of the value information; and
a transfer control means for performing transfer control of the transferred portion from the transfer source user to the transfer destination user.

### (Supplementary Note E2)

The value transfer apparatus according to Supplementary Note E1, wherein the output means
acquires value information associated with each user the biometric authentication of whom is successful and
outputs the acquired value information to the external terminal, and
the acceptance means accepts input of the transferred portion from the external terminal after output of the value information.

### (Supplementary Note E3)

The value transfer apparatus according to Supplementary Note E1 or E2, wherein
the output means outputs a first indicator indicating a first user and a second indicator indicating a second user that are included in the list in such a way as to cause a display unit in the external terminal to display the indicators, and,
when accepting, from the external terminal, operation of moving a displayed position of the first indicator to a displayed position of the second indicator, the acceptance means accepts the first user as the selected transfer source and the second user as the selected transfer destination.

### (Supplementary Note E4)

The value transfer apparatus according to any one of Supplementary Notes E1 to E3, wherein,
when the number of the transfer destination users is two or greater, the acceptance means accepts, from the external terminal, input of a received quantity of the transferred portion for each transfer destination user, and
the transfer control means performs the transfer control by adding the received quantity corresponding to each transfer destination user to the value information associated with each user.

### (Supplementary Note E5)

The value transfer apparatus according to any one of Supplementary Notes E1 to E4, wherein,
when the number of the transfer source users is two or greater, the acceptance means accepts, from the external terminal, each transferred quantity of the value information transferred from each transfer source user as input of the transferred portion, and
the transfer control means performs the transfer control by subtracting the transferred quantity corresponding to each transfer source user from the value information associated with each user.

### (Supplementary Note E6)

The value transfer apparatus according to any one of Supplementary Notes E1 to E3, further including a storage means for storing the value information and a user holding the value information in association with each other,

wherein the transfer control means performs the transfer control by changing association in the storage means for the transferred portion from the transfer source user to the transfer destination user.

### (Supplementary Note E7)

The value transfer apparatus according to any one of Supplementary Notes E1 to E6, wherein the transfer control means
transmits a transfer confirmation to an information terminal corresponding to a user selected as the transfer source and,
when receiving a transfer consent from the information terminal, performs the transfer control with the user as the transfer source user.

### (Supplementary Note E8)

The value transfer apparatus according to any one of Supplementary Notes E1 to E6, wherein
the acceptance means further accepts input of identification information of a user selected as the transfer destination, and
the transfer control means
   specifies identification information of a user selected as the transfer destination, based on a result of the biometric authentication and,
   when the accepted identification information of a user selected as the transfer destination matches the specified identification information, performs the transfer control with the user as the transfer destination user.

### (Supplementary Note E9)

The value transfer apparatus according to any one of Supplementary Notes E1 to E8, wherein the value information includes at least one item out of an electronic point, an electronic coupon, electronic money, crypto assets, and an electronic ticket.

### (Supplementary Note E10)

The value transfer apparatus according to any one of Supplementary Notes E1 to E9, wherein the authentication control means causes an authentication apparatus storing biometric information of a user group including the plurality of users to perform biometric authentication of biometric information of each of the plurality of users.

### (Supplementary Note E11)

The value transfer apparatus according to any one of Supplementary Notes E1 to E9, further including a biometric information storage means for storing biometric information of a user group including the plurality of users,

wherein the authentication control means performs biometric authentication by checking biometric information of the user group against biometric information of each of the plurality of users.

### (Supplementary Note B1)

A value transfer system including:
a face authentication terminal configured to capture a captured image including a plurality of users; and
a value transfer apparatus,
wherein the value transfer apparatus includes:
   an acquisition means for acquiring the captured image from the face authentication terminal;
   an authentication control means for controlling biometric authentication of biometric information of each of the plurality of users extracted from the captured image;
   an output means for outputting a list of two or more users the biometric authentication of whom is successful to the face authentication terminal;
   an acceptance means for accepting, from the face authentication terminal, selection of a transfer source user and a transfer destination user of electronic value information from the list and input of a transferred portion of the value information; and
   a transfer control means for performing transfer control of the transferred portion from the transfer source user to the transfer destination user.

### (Supplementary Note B2)

The value transfer system according to Supplementary Note B1, wherein
the output means
   acquires value information associated with each user the biometric authentication of whom is successful and
   outputs the acquired value information to the face authentication terminal, and
   the acceptance means accepts input of the transferred portion from the face authentication terminal after output of the value information.

### (Supplementary Note C1)

A value transfer method including, by a computer:
acquiring a captured image including a plurality of users;
controlling biometric authentication of biometric information of each of the plurality of users extracted from the captured image;
outputting a list of two or more users the biometric authentication of whom is successful to an external terminal;
accepting, from the external terminal, selection of a transfer source user and a transfer destination user of electronic value information from the list and input of a transferred portion of the value information; and
performing transfer control of the transferred portion from the transfer source user to the transfer destination user.

### (Supplementary Note D1)

A non-transitory computer-readable medium storing a value transfer program causing a computer to execute:
acquisition processing of acquiring a captured image including a plurality of users;
authentication control processing of controlling biometric authentication of biometric information of each of the plurality of users extracted from the captured image;
output processing of outputting a list of two or more users the biometric authentication of whom is successful to an external terminal;
acceptance processing of accepting, from the external terminal, selection of a transfer source user and a transfer destination user of electronic value information from the list and input of a transferred portion of the value information; and
transfer control processing of performing transfer control of the transferred portion from the transfer source user to the transfer destination user.

While the present invention has been described with reference to the example embodiments (and the examples), the present invention is not limited to the aforementioned example embodiments (and the examples). Various changes and modifications that may be understood by a person skilled in the art may be made to the configurations and details of the present invention without departing from the scope of the present invention.

Reference Signs List

| | |
|---|---|
| 10 | VALUE TRANSFER APPARATUS |
| 11 | ACQUISITION UNIT |
| 12 | AUTHENTICATION CONTROL UNIT |
| 13 | OUTPUT UNIT |
| 14 | ACCEPTANCE UNIT |
| 15 | TRANSFER CONTROL UNIT |
| 1000 | VALUE TRANSFER SYSTEM |
| 1000 a | VALUE TRANSFER SYSTEM |
| 1000 b | VALUE TRANSFER SYSTEM |
| 100 | AUTHENTICATION APPARATUS |
| 110 | FACE INFORMATION DB |
| 111 | USER ID |
| 112 | FACE FEATURE INFORMATION |
| 120 | FACE DETECTION UNIT |
| 130 | FEATURE POINT EXTRACTION UNIT |
| 140 | REGISTRATION UNIT |
| 150 | AUTHENTICATION UNIT |
| 200 | VALUE TRANSFER APPARATUS |
| 200 a | VALUE TRANSFER APPARATUS |
| 200 b | VALUE TRANSFER APPARATUS |
| 200 d | VALUE TRANSFER APPARATUS |
| 210 | STORAGE UNIT |
| 211 | PROGRAM |
| 211 a | PROGRAM |
| 211 b | PROGRAM |
| 211 d | PROGRAM |
| 212 | POINT MANAGEMENT INFORMATION |
| 2121 | USER ID |
| 2122 | POINT |
| 213 | USER MANAGEMENT INFORMATION |
| 2131 | USER ID |
| 2132 | PERSONAL INFORMATION |
| 2133 | TERMINAL INFORMATION |
| 2134 | FACE FEATURE INFORMATION |
| 220 | MEMORY |
| 230 | COMMUNICATION UNIT |
| 240 | CONTROL UNIT |
| 241 | ACQUISITION UNIT |
| 242 | AUTHENTICATION CONTROL UNIT |
| 242 d | AUTHENTICATION CONTROL UNIT |
| 243 | OUTPUT UNIT |
| 244 | ACCEPTANCE UNIT |
| 244 a | ACCEPTANCE UNIT |
| 245 | TRANSFER CONTROL UNIT |
| 245 a | TRANSFER CONTROL UNIT |
| 245 b | TRANSFER CONTROL UNIT |
| 300 | FACE AUTHENTICATION TERMINAL |
| 310 | CAMERA |
| 320 | STORAGE UNIT |
| 330 | COMMUNICATION UNIT |
| 340 | INPUT-OUTPUT UNIT |
| 350 | CONTROL UNIT |
| 351 | IMAGE CAPTURE CONTROL UNIT |
| 352 | REGISTRATION UNIT |
| 353 | AUTHENTICATION CONTROL UNIT |
| 354 | DISPLAY CONTROL UNIT |
| 355 | ACCEPTANCE UNIT |
| 400 | INFORMATION TERMINAL |
| 510 | USER LIST DISPLAY SCREEN |
| 510 a | USER LIST DISPLAY SCREEN |
| 511 | USERNAME DISPLAY FIELD |
| 512 | USERNAME DISPLAY FIELD |
| 5121 | USER ID INPUT FIELD |
| 513 | FACIAL IMAGE |
| 514 | FACIAL IMAGE |
| 515 | HELD POINTS DISPLAY FIELD |
| 516 | HELD POINTS DISPLAY FIELD |
| 517 | TRANSFERRED POINTS INPUT FIELD |
| 5181 | TRANSFER SOURCE USER DISPLAY |
| 5182 | TRANSFER DESTINATION USER DISPLAY |
| 519 | TRANSFER EXECUTION BUTTON |
| 520 | TRANSFER RESULT DISPLAY SCREEN |
| 521 | USERNAME DISPLAY FIELD |
| 522 | FACIAL IMAGE |
| 523 | HELD POINTS DISPLAY FIELD |
| 524 | TRANSFERRED POINTS |
| 525 | USERNAME DISPLAY FIELD |
| 526 | FACIAL IMAGE |
| 527 | HELD POINTS DISPLAY FIELD |
| 530 | USER LIST DISPLAY SCREEN |
| 531 | FACIAL IMAGE |
| 532 | USERNAME DISPLAY FIELD |
| 533 | HELD POINTS DISPLAY FIELD |
| 534 | TRANSFERRED QUANTITY INPUT FIELD |
| 534 a | TRANSFERRED QUANTITY |
| 534 b | TRANSFERRED QUANTITY |
| 535 | RECEIVED QUANTITY INPUT FIELD |
| 535 a | RECEIVED QUANTITY |
| 535 b | RECEIVED QUANTITY |
| 536 | TOTAL TRANSFERRED POINTS DISPLAY FIELD |
| 537 | TRANSFER EXECUTION BUTTON |
| 5381 | TRANSFER SOURCE USER DISPLAY |
| 5382 | TRANSFER DESTINATION USER DISPLAY |
| 540 | TRANSFER RESULT DISPLAY SCREEN |
| 541 | TRANSFERRED QUANTITY |
| 542 | TRANSFERRED QUANTITY |
| 543 | RECEIVED QUANTITY |
| 544 | RECEIVED QUANTITY |
| 545 | HELD POINTS DISPLAY FIELD |
| 546 | HELD POINTS DISPLAY FIELD |
| 547 | HELD POINTS DISPLAY FIELD |
| 548 | HELD POINTS DISPLAY FIELD |
| 550 | USER LIST DISPLAY SCREEN |
| N | NETWORK |
| U1 | USER |
| U2 | USER |
| U3 | USER |
| U4 | USER |

What is claimed is:

1. A value transfer apparatus comprising:
at least one storage device configured to store instructions; and
at least one processor configured to execute the instructions to:
acquire a captured image including a plurality of users;
control biometric authentication of biometric information of each of the plurality of users extracted from the captured image;
output a list of two or more users the biometric authentication of whom is successful to an external terminal;
accept, from the external terminal, selection of a transfer source user and a transfer destination user of electronic value information from the list and input of a transferred portion of the value information; and
perform transfer control of the transferred portion from the transfer source user to the transfer destination user.

2. The value transfer apparatus according to claim 1, wherein the at least one processor is further configured to execute the instructions to:
acquire value information associated with each user the biometric authentication of whom is successful,
output the acquired value information to the external terminal, and accept input of the transferred portion from the external terminal after output of the value information.

3. The value transfer apparatus according to claim 1, wherein the at least one processor is further configured to execute the instructions to:
output a first indicator indicating a first user and a second indicator indicating a second user that are included in the list in such a way as to cause a display device in the external terminal to display the indicators, and,
when the value transfer apparatus accepts, from the external terminal, operation of moving a displayed position of the first indicator to a displayed position of the second indicator, accept the first user as the selected transfer source and the second user as the selected transfer destination.

4. The value transfer apparatus according to claim 1, wherein the at least one processor is further configured to execute the instructions to:
when the number of the transfer destination users is two or greater, accept, from the external terminal, input of a received quantity of the transferred portion for each transfer destination user, and
perform the transfer control by adding the received quantity corresponding to each transfer destination user to the value information associated with each user.

5. The value transfer apparatus according to claim 1, wherein the at least one processor is further configured to execute the instructions to:
when the number of the transfer source users is two or greater, accept, from the external terminal, each transferred quantity of the value information transferred from each transfer source user as input of the transferred portion, and
perform the transfer control by subtracting the transferred quantity corresponding to each transfer source user from the value information associated with each user.

6. The value transfer apparatus according to claim 1, wherein the at least one storage device further stores the value information and a user holding the value information in association with each other,
wherein the at least one processor is further configured to execute the instructions to:
perform the transfer control by changing association in the at least one storage device for the transferred portion from the transfer source user to the transfer destination user.

7. The value transfer apparatus according to claim 1, wherein the at least one processor is further configured to execute the instructions to:
transmit a transfer confirmation to an information terminal corresponding to a user selected as the transfer source and,
when the value transfer apparatus receives a transfer consent from the information terminal, perform the transfer control with the user as the transfer source user.

8. The value transfer apparatus according to claim 1, wherein the at least one processor is further configured to execute the instructions to:
accept input of identification information of a user selected as the transfer destination, and
specify identification information of a user selected as the transfer destination, based on a result of the biometric authentication and,
when the accepted identification information of a user selected as the transfer destination matches the specified identification information, perform the transfer control with the user as the transfer destination user.

9. The value transfer apparatus according to claim 1, wherein the value information includes at least one item out of an electronic point, an electronic coupon, electronic money, crypto assets, and an electronic ticket.

10. The value transfer apparatus according to claim 1, wherein the at least one processor is further configured to execute the instructions to:
cause an authentication apparatus storing biometric information of a user group including the plurality of users to perform biometric authentication of biometric information of each of the plurality of users.

11. The value transfer apparatus according to claim 1, wherein the at least one storage device further stores biometric information of a user group including the plurality of users,
wherein the at least one processor is further configured to execute the instructions to:
perform biometric authentication by checking biometric information of the user group against biometric information of each of the plurality of users.

12. A value transfer system comprising:
a face authentication terminal configured to capture a captured image including a plurality of users; and
a value transfer apparatus,
wherein the value transfer apparatus includes:
at least one storage device configured to store instructions; and
at least one processor configured to execute the instructions to:
acquire the captured image from the face authentication terminal;
control biometric authentication of biometric information of each of the plurality of users extracted from the captured image;
output a list of two or more users the biometric authentication of whom is successful to the face authentication terminal;
accept, from the face authentication terminal, selection of a transfer source user and a transfer destination user of electronic value information from the list and input of a transferred portion of the value information; and
perform transfer control of the transferred portion from the transfer source user to the transfer destination user.

13. The value transfer system according to claim 12, wherein the at least one processor is further configured to execute the instructions to:
acquire value information associated with each user the biometric authentication of whom is successful,
output the acquired value information to the face authentication terminal, and
accept input of the transferred portion from the face authentication terminal after output of the value information.

14. A value transfer method comprising, by a computer:
acquiring a captured image including a plurality of users;
controlling biometric authentication of biometric information of each of the plurality of users extracted from the captured image;
outputting a list of two or more users the biometric authentication of whom is successful to an external terminal;
accepting, from the external terminal, selection of a transfer source user and a transfer destination user of electronic value information from the list and input of a transferred portion of the value information; and
performing transfer control of the transferred portion from the transfer source user to the transfer destination user.

15. A non-transitory computer-readable medium storing a value transfer program causing a computer to execute:
acquisition processing of acquiring a captured image including a plurality of users;
authentication control processing of controlling biometric authentication of biometric information of each of the plurality of users extracted from the captured image;
output processing of outputting a list of two or more users the biometric authentication of whom is successful to an external terminal;
acceptance processing of accepting, from the external terminal, selection of a transfer source user and a transfer destination user of electronic value information from the list and input of a transferred portion of the value information; and
transfer control processing of performing transfer control of the transferred portion from the transfer source user to the transfer destination user.
